(19) United States
(12) Patent Application Publication
(10) Pub. No.: US 2001/0022617 A1
(43) Pub. Date: Sep. 20, 2001

(54) System for recycling electronic-image recording apparatus

(76) Inventors: Tetsufumi Takaba, Tokyo (JP); Jun Takayama, Tokyo (JP); Koichi Sato, Tokyo (JP); Kozue Yogata, Tokyo (JP); Masami Fujita, Tokyo (JP); Masaaki Takasaki, Tokyo (JP); Hiroshi Kibayashi, Tokyo (JP)

Correspondence Address: CANTOR COLBURN LLP, 55 Griffin Road South, Bloomfield, CT, 06002, US

(21) Appl. No.: 09/805,704

(22) Filed: Mar. 13, 2001

(30) Foreign Application Priority Data
Mar. 17, 2000 (JP) 076529/2000
Mar. 17, 2000 (JP) 076530/2000
Apr. 5, 2000 (JP) 103684/2000
Apr. 5, 2000 (JP) 103685/2000
Apr. 5, 2000 (JP) 103686/2000
Apr. 5, 2000 (JP) 103687/2000

(51) Int. Cl. H04N 5/225; H04N 9/04; H04N 5/76

(52) U.S. Cl. 348/207; 348/232; 358/906

(57) ABSTRACT

The present invention concerns a system for recycling an electronic-image recording apparatus such as an electronic camera, etc., which can be used again. The system includes a restricting device to restrict an image-capturing operation under a predetermined condition occurring after use of the electronic-image recording apparatus, a readout section to read a first image signal in the basis of an image signal stored in the electronic-image recording apparatus, a converting section to convert the first image signal, read by the readout section, into a second image signal, and a canceling section to cancel the image-capturing restriction set by the restricting device included in the electronic-image recording apparatus.

### BACKGROUND OF THE INVENTION

The present invention relates to a recycling system for an electronic-image recording apparatus such as an electronic camera, etc., which can be used again.

In an electronic still camera, optical images are subjected to photoelectric conversion by an image pick-up means such as CCD (Charge-Coupled Device) and CMOS (Comprementary Metal-Oxide Semiconductor, and the data thus resulted are stored in a storage means. Then, digital data stored in the storage means are used by a color printer to make prints.

Though an electronic still camera is useful on the point of quick output of images and easy image processing after photographing, it has problems that image output operations in a personal computer and a printer are complicated and a price including an apparatus is high, thus, simplicity of operations and cost reduction are further demanded.

Incidentally, in a field of a camera employing a photographic film, there is on the market a camera called a lens-fitted film unit (single-use camera) of a type wherein a film is loaded in a camera in advance, and the camera is taken to a photofinisher after photographing for the number of exposures for development. The camera of this type makes it unnecessary to conduct loading and taking out of a film which have been conducted by a user in a conventional camera, and processing such as printing is conducted in a photofinisher, thus, time and labor for a user are less, and a price is extremely low, which makes it easy for a user to utilize.

### SUMMARY OF THE INVENTION

On the other hand, even in the case of an electronic still camera, it is considered, as a means to realize simplicity and low price for prints, that there is a method to reduce a price by selling on the assumption that an electronic camera which has been used for photographing is collected once to a print store to be reused, namely, on the assumption of the reuse. Due to this method, a user can save time and labor for making prints by itself, by taking to a print store for asking prints. To realize this method, it is important that an electronic still camera is surely circulated to a print store and the circulated electronic still camera can be reused after inspection and adjustment.

However, in the existing electronic still camera, it is possible to continue photographing freely, but it is difficult to reduce a price under the assumption of the circulation. An object of the invention is to provide an electronic-image recording apparatus such as an electronic still camera which is suitable for the aforesaid method and is inexpensive.

For realizing the aforesaid method, another object of the invention is to provide a collection apparatus of an image forming apparatus capable of conducting collection or re-providing efficiently and a collection system employing the collection apparatus.

Accordingly, to overcome the cited shortcomings, the abovementioned object of the present invention can be attained by the recycling system described as follow.

1) A system for recycling an electronic-image recording apparatus, which includes a restricting device to restrict an image-capturing operation under a predetermined condition occurring after use of the electronic-image recording apparatus, comprising: a readout section to read a first image signal stored in the electronic-image recording apparatus; a converting section to convert the first image signal, read by the readout section, into a second image signal; and a canceling section to cancel the image-capturing restriction set by the restricting device included in the electronic-image recording apparatus.

2) The system of item 1, further comprising: a processing section for applying a predetermined processing to the electronic-image recording apparatus, in order to reuse it.

3) The system of item 2, wherein the processing section conducts a mechanical inspection process for the electronic-image recording apparatus.

4) The system of item 2, wherein the electronic-image recording apparatus memorizes identification data, and the processing section changes the identification data memorized in the electronic-image recording apparatus.

5) The system of item 2, wherein the processing section initializes the electronic-image recording apparatus.

6) The system of item 2, wherein the processing section erases data memorized in the electronic-image recording apparatus.

7) The system of item 2, wherein the processing section exchanges unusable and/or worn-out parts of the electronic-image recording apparatus with new parts.

8) The system of item 1, further comprising: a recording section to record image information on a recording medium, based on the second image signal.

9) The system of item 8, wherein the recording section records the image information on the recording medium in a visible form.

10) The system of item 8, wherein the recording section stores the image information in the recording medium in a form of digital data.

11) The system of item 1, further comprising: an image-capturable state notifying section to notify that a number of images, recorded in the electronic-image recording apparatus, is within a range of a predetermined number, when the number of images does not exceed the predetermined number of images to be stored in the electronic-image recording apparatus.

12) The system of item 1, further comprising: an inserting section into which the electronic-image recording apparatus can be inserted; and a storing section to store the electronic-image recording apparatus from which the first image signal is already read out by the readout section, in such a manner that a person, other than predetermined personnel, cannot remove the electronic-image recording apparatus from the storing section.

13) The system of item 1, wherein the second image signal is a general purpose image signal.

Further, to overcome the abovementioned problems, other recycling systems, embodied in the present invention, will be described as follow:

Structure (1)

A recycling system for an electronic-image recording apparatus having a restriction means to restrict photographing by the prescribed condition after the start of photographing, comprising a read-out means to read out a first image signal stored in the electronic-image recording apparatus, a conversion means to convert the first image signal read out by the read-out means into a second image signal, and a releasing means that releases the aforesaid restriction given by the restriction means of the electronic-image recording apparatus.

Structure (2)

The recycling system for an electronic-image recording apparatus according to Structure (1), wherein there is provided an electronic-image recording apparatus processing means.

Structure (3)

The recycling system for an electronic-image recording apparatus according to Structure (1), wherein there is provided a recording means that records image information on an image recording medium based on the second image signal stated above.

Structure (4)

The recycling system for an electronic-image recording apparatus according to Structure (1), wherein there is provided a notifying means that notifies that the number of images recorded is not more than the prescribed number, when the number of images recorded on the electronic-image recording apparatus is not more than the prescribed number.

Structure (5)

The recycling system for an electronic-image recording apparatus according to Structure (1), wherein there are provided an inserting means capable of inserting the electronic-image recording apparatus and a keeping means that can keep the electronic-image recording apparatus where the first image information was read out by the read-out means so that a person other than the prescribed person cannot take out.

Structure (6)

A recycling system for an electronic-image recording apparatus having therein a processing apparatus having a conversion means that reads out a first image signal stored in the electronic-image recording apparatus by sending and receiving signals with the electronic-image recording apparatus having a photoelectric conversion means that converts optical images into electric signals, a storage means that stores a first image signal based on the electric signals and a restriction means that restricts photographing with the prescribed condition from the start of photographing, and converts the first image signal read out into second image signals and a processing apparatus for reuse having a releasing means that releases the restriction given by the restriction means of the electronic-image recording apparatus.

Structure (7)

The recycling system for an electronic-image recording apparatus according to Structure (6), wherein the processing apparatus for reuse has a means to change ID information stored in the electronic-image recording apparatus.

Structure (8)

A recycling system for an electronic-image recording apparatus having therein a processing apparatus having a conversion means that reads an image signal stored in the electronic-image recording apparatus by sending and receiving signals with an electronic-image recording apparatus provided with a photoelectric conversion means that converts an optical image into an electric signal, a storage means that stores an image signal based on the electric signal, and a restriction means that restricts photographing by means of the prescribed condition from the start of photographing, and converts the image signal thus read out into a second image signal, and a processing apparatus for reuse having therein a releasing means that releases restriction given by the restriction means of the electronic-image recording apparatus and a processing means that conducts the prescribed processing for reusing the electronic-image recording apparatus.

Structure (9)

The recycling system for an electronic-image recording apparatus according to Structure (8), wherein the prescribed processing for the aforesaid reusing is a function inspection processing of the electronic-image recording apparatus.

Structure (10)

The recycling system for an electronic-image recording apparatus according to Structure (8) or Structure (9), wherein the prescribed processing for the aforesaid reusing is a processing to change ID information stored in the electronic-image recording apparatus.

Structure (11)

The recycling system for an electronic-image recording apparatus according to either one of Structure (8)-Structure (10), wherein the prescribed processing for the aforesaid reusing includes a processing for initializing the electronic-image recording apparatus.

Structure (12)

The recycling system for an electronic-image recording apparatus according to Structure (11), wherein the processing to initialize includes a processing to erase contents stored in the storage means.

Structure (13)

The recycling system for an electronic-image recording apparatus according to either one of Structure (6)-Structure (12), wherein the second image signal is a general-purpose image signal.

Structure (14)

The recycling system for an electronic-image recording apparatus according to either one of Structure (6)-Structure (13), wherein the prescribed condition is a period of time or the number of exposures executed from the start of photographing.

Structure (15)

The recycling system for an electronic-image recording apparatus according to either one of Structure (6)-Structure (14), wherein the electronic-image recording apparatus has a reproduction means, and the prescribed condition is a reproduction time.

Structure (16)

The recycling system for an electronic-image recording apparatus according to either one of Structure (6)-Structure (15), wherein the processing apparatus has a recording means which records the second image signal on an image recording medium.

Structure (17)

The recycling system for an electronic-image recording apparatus according to Structure (16), wherein the recording means conducts a print processing.

Structure (18)

The recycling system for an electronic-image recording apparatus according to Structure (16) or Structure (17), wherein the recording means conducts recording electronically on the recording medium.

Structure (19)

The recycling system for an electronic-image recording apparatus according to either one of Structure (6)-Structure (18), wherein the electronic-image recording apparatus is restricted in terms of output of the image signal to the outside.

Structure (20)

The recycling system for an electronic-image recording apparatus according to Structure (19), wherein the restriction stated above is released by input of a specific password.

Structure (21)

The recycling system for an electronic-image recording apparatus according to either one of Structure (6)-Structure (20), wherein the output of the image signal to the outside from the electronic-image recording apparatus can be conducted only by the apparatus for reuse.

Structure (22)

The recycling system for an electronic-image recording apparatus according to either one of Structure (6)-Structure (21), wherein there is provided a notifying means that notifies that the number of images recorded is not more than the prescribed number, when the number of images recorded on the electronic-image recording apparatus is not more than the prescribed number.

Structure (23)

A processing apparatus for reuse of an electronic-image recording apparatus having therein a conversion means that reads out a first image signal stored in the electronic-image recording apparatus by sending and receiving signals between a photoelectric conversion means that converts optical images into electric signals and the electronic-image recording apparatus having a storage means that stores a first image signal based on the electric signals and a restriction means that restricts photographing with the prescribed condition from the start of photographing, and converts the first image signal read out into second image signals, and a releasing means that releases the restriction given by the restriction means.

Structure (24)

The processing apparatus for reuse according to Structure (23), wherein there is provided a means to conduct the prescribed processing for the reuse.

Structure (25)

The processing apparatus for reuse according to Structure (24), wherein the prescribed processing for the reuse is a function inspection processing for the electronic-image recording apparatus.

Structure (26)

The processing apparatus for reuse according to Structure (24) or Structure (25), wherein the prescribed processing for the reuse is a processing to change ID information recorded in the electronic-image recording apparatus.

Structure (27)

The processing apparatus for reuse according to either one of Structure (24)-Structure (26), wherein the processing for the reuse includes a processing to initialize the electronic-image recording apparatus.

Structure (28)

The processing apparatus for reuse according to Structure (27), wherein the processing to initialize includes a processing to erase contents stored in the storage means.

Structure (29)

The processing apparatus for reuse according to either one of Structure (23)-Structure (28), wherein the second image signal is a general-purpose image signal.

Structure (30)

The processing apparatus for reuse according to either one of Structure (23)-Structure (29), wherein the prescribed condition is a period of time or the number of exposures executed from the start of photographing.

Structure (31)

The processing apparatus for reuse according to either one of Structure (23)-Structure (30), wherein the electronic-image recording apparatus has a reproduction means, and the prescribed condition is a reproduction time.

Structure (32)

The processing apparatus for reuse according to either one of Structure (23)-Structure (31), wherein the processing apparatus has a recording means which records the second image signal on an image recording medium.

Structure (33)

The processing apparatus for reuse according to Structure (32), wherein the recording means conducts print processing.

Structure (34)

The processing apparatus for reuse according to Structure (32) or Structure (33), wherein the recording means conducts recording electronically on the recording medium.

Structure (35)

The processing apparatus for reuse according to either one of Structure (23) or Structure (34), wherein the electronic-image recording apparatus is restricted in terms of output of the image signal to the outside.

Structure (36)

The processing apparatus for reuse according to Structure (35), wherein the restriction stated above is released by input of a specific information.

Structure (37)

The processing apparatus for reuse according to either one of Structure (23) or Structure (36), wherein the output of the image signal to the outside from the electronic-image recording apparatus can be conducted only by the processing apparatus for reuse.

Structure (38)

The processing apparatus for reuse according to either one of Structure (23) or Structure (37), wherein there is provided a notifying means that notifies that the number of images recorded is not more than the prescribed number, when the number of images recorded on the electronic-image recording apparatus is not more than the prescribed number.

Structure (39)

A reprocessing system of an image recording apparatus having therein a processing apparatus for reuse provided with a conversion means that reads an image signal stored in the electronic-image recording apparatus by sending and receiving signals with an electronic-image recording apparatus provided with a photoelectric conversion means that converts an optical image into an electric signal, a storage means that stores an image signal based on the electric signal, and a restriction means that restricts photographing by means of the prescribed condition from the start of photographing, and converts the image signal thus read out into a second image signal and with a releasing means that releases the restriction given by the restriction means, and a reproduction processing apparatus that conducts the prescribed processing for reusing the electronic-image recording apparatus.

Structure (40)

The reprocessing system according to Structure (39), wherein the prescribed processing for reusing is a function inspection processing for the electronic-image recording apparatus.

Structure (41)

The reprocessing system according to Structure (40), wherein the prescribed processing for reusing is a processing to change ID information recorded in the electronic-image recording apparatus.

Structure (42)

The reprocessing system according to either one of Structure (39)-Structure (41), wherein the processing for reusing includes a processing for initializing the electronic-image recording apparatus.

Structure (43)

The reprocessing system according to Structure (42), wherein the processing for initializing includes a processing to erase contents stored in the storage means.

Structure (44)

The reprocessing system according to either one of Structure (39)-Structure (43), wherein the second image signal is a general-purpose image signal.

Structure (45)

The reprocessing system according to either one of Structure (39)-Structure (44), wherein the prescribed condition is a period of time or the number of exposures executed from the start of photographing.

Structure (46)

The reprocessing system according to either one of Structure (39)-Structure (45), wherein the electronic-image recording apparatus has a reproduction means, and the prescribed condition is a reproduction time.

Structure (47)

The reprocessing system according to either one of Structure (39)-Structure (46), wherein the processing apparatus has a recording means which records the second image signal on an image recording medium.

Structure (48)

The reprocessing system according to Structure (47), wherein the recording means conducts print processing.

Structure (49)

The reprocessing system according to Structure (47) or Structure (48), wherein the recording means conducts recording electronically on the recording medium.

Structure (50)

The reprocessing system according to either one of Structure (39)-Structure (49), wherein the electronic-image recording apparatus is restricted in terms of output of the image signal to the outside.

Structure (51)

The reprocessing system according to Structure (50), wherein the restriction stated above is released by input of a specific information.

Structure (52)

The reprocessing system according to either one of Structure (39)-Structure (51), wherein there is provided a notifying means that notifies that the number of images recorded is not more than the prescribed number, when the number of images recorded on the electronic-image recording apparatus is not more than the prescribed number.

Structure (53)

A recovery apparatus for an electronic-image recording apparatus having therein an insertion section into which an electronic-image recording apparatus can be inserted, a readout means that reads out image information from an electronic-image recording apparatus inserted in the insertion section, a processing means that processes the image information read out by the read-out means, and a keeping section that can keep the electronic-image recording apparatus from which the image information has been read out so that it may not be taken out by those other than a proscribed person.

Structure (54)

The recovery apparatus for an electronic-image recording apparatus according to Structure (53), wherein the processing means is a means to record image information on a recording medium as a visible image.

Structure (55)

The recovery apparatus for an electronic-image recording apparatus according to Structure (55) or Structure (56), wherein the processing means is a display means that displays image information as a visible image.

Structure (56)

The recovery apparatus for an electronic-image recording apparatus according to either one of Structure (53)-Structure (55), wherein the processing means is a means to store the image information in a storage medium as image data.

Structure (57)

The recovery apparatus for an electronic-image recording apparatus according to either one of Structure (53)-Structure (56), wherein the processing means is a means to transmit the image information to an external computer or a server through a communication means.

Structure (58)

The recovery apparatus for an electronic-image recording apparatus according to either one of Structure (53)-Structure (57), wherein there is provided a function to eject an electronic-image recording apparatus out of an apparatus when image information cannot be read out from the electronic-image recording apparatus properly, or when the image information is not present, in the case where the readout means reads image information properly and there still remain exposable frames.

Structure (59)

The recovery apparatus for an electronic-image recording apparatus according to Structure (58), wherein the display means displays that image information cannot be read when the image information cannot be read properly from the electronic-image recording apparatus.

Structure (60)

The recovery apparatus for an electronic-image recording apparatus according to Structure (58) or Structure (59), wherein the electronic-image recording apparatus is ejected out of an apparatus from the insertion section

Structure (61)

The recovery apparatus for an electronic-image recording apparatus according to Structure (58) or Structure (59), wherein the electronic-image recording apparatus is ejected out of an apparatus from an outlet other than the insertion section.

Structure (62)

The recovery apparatus for an electronic-image recording apparatus according to either one of Structure (53)-Structure (61), wherein the electronic-image recording apparatus is kept in the keeping section, when the read-out means reads out image information properly and there still remain exposable frames and when reuse of the electronic-image recording apparatus is not required, or when all pieces of image information have been read properly out of the electronic-image recording apparatus.

Structure (63)

The recovery apparatus for an electronic-image recording apparatus according to either one of Structure (53)-Structure (62), wherein the display means displays that there has been conducted the processing to make it impossible to reread the image information from the electronic-image recording apparatus by making it impossible to read by means of a processing means to make it impossible to reread the image information from the electronic-image recording apparatus, when the read-out means reads out properly and there still remain exposable frames and when reuse of the electronic-image recording apparatus is not required, or when all pieces of image information have been read properly out of the electronic-image recording apparatus.

Structure (64)

The recovery apparatus for an electronic-image recording apparatus according to either one of Structure (53)-Structure (63), wherein there are provided a counting means that counts the number of electronic-image recording apparatuses kept in the keeping section and a notifying means to notify the counted value.

Structure (65)

The recovery apparatus for an electronic-image recording apparatus according to Structure (64), wherein the notifying means is a means to notify that the counted value has reached the prescribed value.

Structure (66)

The recovery apparatus for an electronic-image recording apparatus according to Structure (64) or Structure (65), wherein the notifying means is a means to transmit information to an external computer or server through a communication means.

Structure (67)

The recovery apparatus for an electronic-image recording apparatus according to either one of Structure (53)-Structure (66), wherein there is provided a receiving means that receives information from an external computer or server.

Structure (68)

The recovery apparatus for an electronic-image recording apparatus according to either one of Structure (53)-Structure (67), wherein there is provided a function to conduct accounting.

Structure (69)

A recovery system for an electronic-image recording apparatus wherein an electronic-image recording apparatus having therein an image information generating means that generates image information based on an optical image and a storage means that stores image information generated is recovered by a recovery apparatus for an electronic-image recording apparatus having therein an insertion section into which the electronic-image recording apparatus can be inserted, a read-out means that reads out image information from the electronic-image recording apparatus inserted into the insertion section, a processing means that processes image information read out by the read-out means, and a keeping section where the electronic-image recording apparatus from which the image information has been read out can be kept.

Structure (70)

A processing apparatus for an electronic-image recording apparatus having therein an insertion section into which an electronic-image recording apparatus can be inserted,

a read-out means that reads out image information from the electronic-image recording apparatus inserted into the insertion section, a processing means that processes the image information read out by the read-out means, an accounting processing means, and a condition setting means that makes the electronic-image recording apparatus to be in the prescribed photographable state complying with the accounting processing after the prescribed accounting processing has been conducted by the accounting processing means.

Structure (71)

The processing apparatus for an electronic-image recording apparatus according to Structure (70), wherein the processing means is a means to record image information on a recording medium as a visible image.

Structure (72)

The processing apparatus for an electronic-image recording apparatus according to Structure (70) or Structure (71), wherein the processing means is a display means that displays image information as a visible image having therein an insertion section into which an electronic-image recording apparatus can be inserted,

Structure (73)

The processing apparatus for an electronic-image recording apparatus according to either one of Structure (70)-Structure (72), wherein the processing means is a means to store image information in a storage medium as image data.

Structure (74)

The processing apparatus for an electronic-image recording apparatus according to either one of Structure (70)-Structure (73), wherein the processing means is a means to transmit image information to an external computer or server through a communication means.

Structure (75)

The processing apparatus for an electronic-image recording apparatus according to either one of Structure (70)-Structure (74), wherein there is provided a function to eject the electronic-image recording apparatus out of an apparatus when image information can be read out properly and the prescribed accounting processing has been conducted, or when no image information is present, in the case where the read-out means cannot read image information properly from the electronic-image recording apparatus and in the case where image information is read out properly and there still remain exposable frames.

Structure (76)

The processing apparatus for an electronic-image recording apparatus according to Structure (75), wherein, when image information cannot be read out properly from the electronic-image recording apparatus, the display means indicates that image information cannot be read out.

Structure (77)

The processing apparatus for an electronic-image recording apparatus according to Structure (75) or Structure (76), wherein the electronic-image recording apparatus is ejected from the insertion section to the outside of an apparatus.

Structure (78)

The processing apparatus for an electronic-image recording apparatus according to Structure (75) or Structure (76), wherein the electronic-image recording apparatus is ejected from an outlet which is different from the insertion section to the outside of an apparatus.

Structure (79)

The processing apparatus for an electronic-image recording apparatus according to either one of Structure (73) or Structure (78), wherein the aforesaid prescribed accounting processing is an accounting processing to initialize the electronic-image recording apparatus to be in the photographable state, and when image information is properly read out and the prescribed accounting processing is conducted, an ejection is conducted after the condition setting means conducts the processing for initializing the electronic-image recording apparatus to be in the photographable state.

Structure (80)

The processing apparatus for an electronic-image recording apparatus according to either one of Structure (70) or Structure (79), wherein the processing for initializing the electronic-image recording apparatus to be in the photographable state includes checking of functions of the electronic-image recording apparatus.

Structure (81)

The processing apparatus for an electronic-image recording apparatus according to either one of Structure (70) or Structure (80), wherein the electronic-image recording apparatus is kept in a keeping section provided in an apparatus, when the read-out means reads out image information properly and there still remain exposable frames and when the reuse of the electronic-image recording apparatus is not required, or when image information is read out properly from the electronic-image recording apparatus and when the accounting processing for initializing the electronic-image recording apparatus to be in the photographable state is not conducted.

Structure (82)

The processing apparatus for an electronic-image recording apparatus according to either one of Structure (70) or Structure (81), wherein there is conducted the processing to make rereading of image information from the electronic-image recording apparatus to be impossible, when image information is read out properly from the electronic-image recording apparatus and there still remain exposable frames and when the reuse of the electronic-image recording apparatus is not required, or when image information is read out properly from the electronic-image recording apparatus and when the prescribed accounting processing is not conducted.

Structure (83)

The processing apparatus for an electronic-image recording apparatus according to Structure (82), wherein there is provided a display means which displays that processing to make rereading of image information from the electronic-image recording apparatus has been conducted.

Structure (84)

The processing apparatus for an electronic-image recording apparatus according to either one of Structure (70)-Structure (83), wherein there are provided a counting means that counts the number of electronic-image recording apparatuses kept in the keeping section and a notifying means to notify the counted value.

Structure (85)

The processing apparatus for an electronic-image recording apparatus according to Structure (84), wherein the notifying means is a means to notify that the counted value has reached the prescribed value.

Structure (86)

The processing apparatus for an electronic-image recording apparatus according to Structure (84) or Structure (85), wherein the notifying means is a means to transmit information to an external computer through a communication means.

Structure (87)

The recovery apparatus for an electronic-image recording apparatus according to either one of Structure (70)-Structure (86), wherein there is provided a receiving means that receives information from an external computer.

Structure (88)

A reusing system for an electronic-image recording apparatus wherein an electronic-image recording apparatus is made to be reusable by a processing apparatus having therein an insertion section into which an electronic-image recording apparatus having therein an image information generating means that generates image information based on an optical image and a storage means that stores generated image information can be inserted, a read-out means for reading out image information from the electronic-image recording apparatus inserted into the insertion section, a processing means that processes image information read out by the readout means, an accounting processing means, and a means for initializing the electronic-image recording apparatus to be in the photographable state after the prescribed accounting processing is conducted by the accounting means.

Structure (89)

The reusing system for an electronic-image recording apparatus according to Structure (88), wherein the means to initialize the electronic-image recording apparatus to be in the photographable state also conducts function checking for the electronic-image recording apparatus.

Structure (90)

An electronic-image recording apparatus having therein a photoelectric conversion means that converts an optical image into an electric signal, a storage means that stores an image signal based on the electric signal, a means to output to the outside for outputting the stored image signal to the outside, and an image processing means which can be connected to the means to output to the outside, and conducts image processing for the image signal to be outputted to the outside, wherein the image processing means is capable of being mounted on and dismounted from the electronic-image recording apparatus.

Structure (91)

The electronic-image recording apparatus according to Structure (90), wherein there is provided an image signal erasing means that erases at least a part of the stored image signal.

Structure (92)

The electronic-image recording apparatus according to Structure (90) or Structure (91), wherein the stored image signal is outputted to the outside without being subjected to the image reproduction processing.

Structure (93)

The electronic-image recording apparatus according to either one of Structure (90)-Structure (92), wherein there is provided a restriction means that restricts photographing when the prescribed restriction condition is formed after the start of photographing.

Structure (94)

The electronic-image recording apparatus according to Structure (93), wherein the forming of the prescribed restriction condition means that the prescribed period of time has passed from the start of photographing, or photographing operations for the prescribed number of frames have been carried out.

Structure (95)

The electronic-image recording apparatus according to either one of Structure (90)-Structure (94), wherein the image signal is transmitted to the means to output to the outside only when the prescribed output condition is formed.

Structure (96)

The electronic image recording and reproducing apparatus according to either one of Structure (90)-Structure (95), wherein the image processing includes color conversion processing.

Structure (97)

An electronic image recording system having therein an electronic-image recording apparatus provided with a photoelectric conversion means that converts an optical image into an electric signal, a storage means that stores an image signal based on the electric signal, and with a means to output to the outside for outputting the stored image signal to the outside, and an image processing apparatus that conducts image processing for the image signal stored in the storage means.

Structure (98)

The electronic image recording system according to Structure (97), wherein there is provided an image signal erasing means that erases at least a part of the stored image signal.

Structure (99)

The electronic image recording system according to Structure (97) or Structure (98), wherein the stored image signal is outputted to the outside without being subjected to image reproduction processing.

Structure (100)

The electronic image recording system according to either one of Structure (97)-Structure (99), wherein there is provided a restriction means that restricts photographing when the prescribed restriction condition is formed after the start of photographing.

Structure (101)

The electronic image recording system according to Structure (100), wherein the forming of the prescribed restriction condition means that the prescribed period of time has passed from the start of photographing, or photographing operations for the prescribed number of frames have been carried out.

Structure (102)

The electronic image recording system according to either one of Structure (97) or Structure (101), wherein the image signal is transmitted to the means to output to the outside only when the prescribed output condition is formed.

Structure (103)

The electronic image recording and reproducing system according to either one of Structure (97) or Structure (102), wherein the image processing includes color conversion processing.

Structure (104)

An electronic-image recording apparatus used for the electronic image recording and reproducing system according to either one of Structure (97)-Structure (103).

Structure (105)

An image processing apparatus used for the electronic image recording and reproducing system according to either one of Structure (97)-Structure (103).

Structure (106)

An electronic-image recording apparatus having therein a photoelectric conversion means that obtains an electric signal by converting an optical image, a storage means that stores a first image signal based on the electric signal, and an image conversion means that reads out the stored first image signal and converts the first image signal thus read out into the second image signal, wherein the image conversion means can be mounted on and dismounted from the electronic-image recording apparatus.

Structure (107)

The electronic-image recording apparatus according to Structure (106), wherein the image conversion means has an image processing section.

Structure (108)

The electronic image recording and reproducing apparatus according to Structure (107), wherein the image processing section conducts color conversion processing.

Structure (109)

The electronic-image recording apparatus according to either one of Structure (105)-Structure (108), wherein there is provided a restriction means that restricts photographing when the prescribed restriction condition is formed after the start of photographing.

Structure (110)

The electronic-image recording apparatus according to Structure (109), wherein the forming of the prescribed restriction condition means that the prescribed period of time has passed from the start of photographing, or photographing operations for the prescribed number of frames have been carried out.

Structure (111)

The electronic-image recording apparatus according to either one of Structure (105)-Structure (110), wherein there is provided an output restriction means that transmits image signals to the outside only when the prescribed output condition is formed.

Structure (112)

The electronic-image recording apparatus according to Structure (111), wherein what the prescribed output condition is formed is that the output restriction means has recognized that information corresponding to certification information stored in the electronic-image recording apparatus is inputted.

Structure (113)

The electronic-image recording apparatus according to either one of Structure (106)-Structure (112), wherein there is provided an image signal erasing means that erases at least a part of the stored first image signal.

Structure (114)

An image recording system including a processing apparatus provided with an electronic-image recording apparatus having therein a photoelectric conversion means that obtains an electric signal by converting an optical image, a storage means that stores a first image signal based on the electric signal, and an image signal outputting means that outputs the stored first image signal, a read-out means that reads out a first image signal recorded in the electronic-image recording apparatus by conducting transmitting and receiving signals with the electronic-image recording apparatus, and with an image conversion means that converts the first image signal read out into a second image signal.

Structure (115)

The image recording system according to Structure (114), wherein the image conversion means of the electronic-image recording apparatus has an image processing section.

Structure (116)

The image recording system according to Structure (115), wherein processing conducted by the image processing section includes color conversion processing.

Structure (117)

The image recording system according to either one of Structure (114)-Structure (116), wherein the electronic-image recording apparatus has a restriction means that restricts photographing when the prescribed restriction condition is formed after the start of photographing.

Structure (118)

The image recording system according to Structure (117), wherein the forming of the prescribed restriction condition means that the prescribed period of time has passed from the start of photographing, or photographing operations for the prescribed number of frames have been carried out.

Structure (119)

The image recording system according to either one of Structure (115)-Structure (118), wherein the electronic-image recording apparatus is provided with an output restriction means that transmits image signals to the outside only when the prescribed output condition is formed.

Structure (120)

The image recording system according to Structure (119), wherein what the prescribed output condition is formed is that the output restriction means has recognized that information corresponding to certification information stored in the electronic-image recording apparatus is inputted.

Structure (121)

The image recording system according to either one of Structure (114)-Structure (120), wherein the electronic-image recording apparatus is provided with an image signal erasing means that erases at least a part of the stored first image signal.

Structure (122)

An image recording and reproducing system including a processing apparatus provided with an electronic-image recording apparatus having therein a photoelectric conversion means that obtains an electric signal by converting an optical image, a storage means that stores a first image signal based on the electric signal, and an image outputting means that outputs the stored first image signal, a read-out means that reads out a first image signal recorded in the electronic-image recording apparatus by conducting transmitting and receiving signals with the electronic-image recording apparatus, and with an image conversion means that converts the first image signal read out into a second image signal, and including an image recording apparatus that conducts image recording by using output from the processing apparatus.

Structure (123)

The image recording and reproducing system according to Structure (122), wherein an accounting means that conducts accounting processing in the prescribed mode is provided.

Structure (124)

The image recording and reproducing system according to Structure (123), wherein the accounting processing is conducted in accordance with reading of the first image signal.

Structure (125)

The image recording and reproducing system according to either one of Structure (122)-Structure (124), wherein the image conversion means of the electronic-image recording apparatus has an image processing section.

Structure (126)

The image recording and reproducing system according to Structure (125), wherein processing conducted by the image processing section includes color conversion processing.

Structure (127)

The image recording and reproducing system according to either one of Structure (122)-Structure (126), wherein the electronic-image recording apparatus has a restriction means that restricts photographing when the prescribed restriction condition is formed after the start of photographing.

Structure (128)

The image recording and reproducing system according to Structure (127), wherein the forming of the prescribed restriction condition means that the prescribed period of time has passed from the start of photographing, or photographing operations for the prescribed number of frames have been carried out.

Structure (129)

The image recording and reproducing system according to either one of Structure (122)-Structure (128), wherein the electronic-image recording apparatus is provided with an output restriction means that transmits image signals to the outside only when the prescribed output condition is formed.

Structure (130)

The image recording and reproducing system according to Structure (129), wherein what the prescribed output condition is formed is that the output restriction means has recognized that information corresponding to certification information stored in the electronic-image recording apparatus is inputted.

Structure (131)

The image recording and reproducing system according to either one of Structure (122)-Structure (130), wherein the electronic-image recording apparatus is provided with an image signal erasing means that erases at least a part of the stored first image signal.

Structure (132)

A processing apparatus used for the image recording system according to either one of Structure (114)-Structure (121) or for the image recording and reproducing system according to either one of Structure (122)-Structure (131).

### BRIEF DESCRIPTION OF THE DRAWINGS

Other objects and advantages of the present invention will become apparent upon reading the following detailed description and upon reference to the drawings in which:

FIG. 1 is a schematic diagram showing the total system related to the first embodiment;

FIG. 2 is a block diagram of electronic still camera 100 related to the first embodiment;

FIG. 3 is a front view of electronic still camera 100;

FIG. 4 is a rear view of electronic still camera 100;

FIG. 5 is a diagram showing processing apparatus 200 constituting a recycling system of electronic still camera related to the first embodiment, and processing apparatus for reuse 300;

FIG. 6 is a perspective view of processing apparatus 200 related to the first embodiment;

FIG. 7 is a flow chart for illustrating the total system including operations of processing apparatus 200 related to the first embodiment;

FIG. 8 is a diagram showing processing apparatus for reuse 200 and processing apparatus for reproduction 300 both constituting a recycling system for an electronic still camera related to the second embodiment;

FIG. 9 is a flow chart for illustrating the total system including operations of processing apparatus for reuse 200 related to the second embodiment;

FIG. 10 is a block diagram showing recovery apparatus 200 related to the third embodiment;

FIG. 11 is a perspective view of recovery apparatus 200;

FIG. 12 is a perspective view of recovery apparatus 200;

FIG. 13 is a diagram showing an enlarged insertion opening;

FIG. 14 is a flow chart for illustrating the total system including operations of recovery apparatus 200 related to the third embodiment;

FIG. 15 is a flow chart for illustrating the total system including operations of processing apparatus 200 related to the fourth embodiment;

FIG. 16 is a block diagram of electronic still camera 100 related to the fifth embodiment;

FIG. 17 is a diagram showing processing apparatus 200 constituting the recycling system for an electronic still camera related to the fifth embodiment;

FIG. 18 is a perspective view of processing apparatus 200;

FIG. 19 is a flow chart for illustrating the total system including operations of processing apparatus 200 related to the fifth embodiment;

FIG. 20 is a schematic diagram showing the total system related to the sixth embodiment;

FIG. 21 is a block diagram of electronic still camera 100 related to the sixth embodiment;

FIG. 22 is a block diagram showing adaptor 200 related to the sixth embodiment;

FIG. 23 is a block diagram showing processing apparatus 300 related to the sixth embodiment; and

FIG. 24 is a perspective view of processing apparatus 300.

### DETAILED DESCRIPTION OF THE PREFERRED EMBODIMENT

A recycling system of an electronic-image recording apparatus in the invention is a recycling system of an electronic-image recording apparatus having therein a restriction means (restricting device) that restricts photographing under the prescribed condition after the start of photographing. The recycling system of an electronic-image recording apparatus in the invention has therein a read-out means (read out section) that reads out the first image signal stored in the electronic-image recording apparatus, a conversion means (converting section) that converts the first image signal read out by the read-out means into the second image signal, and a releasing means (canceling section) that releases restriction given by the restriction means of the electronic-image recording apparatus.

Therefore, the restriction means restricts photographing when the prescribed condition comes, for example, when the number of exposures reaches the prescribed number after being sold. Therefore, a user learns, from inability of photographing, that the term of validity for the use of an electronic-image recording apparatus has expired. Since it is impossible to take out image data on the user side, on the other hand, a user having the electronic-image recording apparatus which rejects further photographing needs to take the electronic-image recording apparatus to a prescribed place such as a photofinisher when the user desires images based on image data obtained through photographing, which improves the collection rate of the electronic-image recording apparatus. Further, on the side of a maker who collected electronic-image recording apparatuses through photofinishers, it is possible to use the releasing means to release the restriction given by the restriction means for the reuse of necessary parts, and thereby to provide an electronic-image recording apparatus at low cost.

A read-out means, a conversion means and a releasing means may be incorporated collectively in a united apparatus, or some of them may be incorporated in a separate apparatus. Further, when some of them are incorporated in a separate apparatus, each apparatus may either be connected to others through the wire system or the radio system, or be isolated from others.

For example, there are given a system having a read-out means, a processing apparatus having a conversion means and a processing apparatus for reuse having a releasing means each being a separate apparatus, and a system representing a processing apparatus for reuse having all of a read-out means, a conversion means and a releasing means in a united apparatus.

An electronic-image recording apparatus mentioned in the invention is one like a digital still camera, for example, but the invention is not limited to this. It is preferable that an electronic-image recording apparatus has therein a photoelectric conversion means that converts an optical image into an electric signal (hereinafter referred to as image information generating means, or image pick-up means), a storage means that stores the image signal based on the electric signal, and a restriction means that restricts photographing under the prescribed condition after the start of photographing. The storage means has only to store either analog signals or digital signals, or both of them.

As a photoelectric conversion means, photoelectric conversion elements such as CCD and CMOS are preferable. As a storage means, there are given various memories, various ROMs (including mask ROM, flash memory, EPROM and EPROM), various RAMs (including DRAM, SDRAM, miniature card, compact flash, smart media, PC card and other semiconductor memories), hard discs, various information recording media (FD, MD, MO, CD-R, CD-RW, DVD-R, DVD-RW, MT, DAT and Zip), and recording and reading apparatuses therefore.

As a restriction means of an electronic-image recording apparatus, there is given a means which makes it impossible to photograph when the prescribed condition is satisfied after the start of photographing. As the prescribed condition which has only to be one that gives restriction for promoting circulation of electronic-image recording apparatuses, there are given the number of exposures made, storage capacity of images resulted from photographing, a period of time from a purchase of the electronic-image recording apparatus, a period of time from the start of photographing and the voltage drop of power source incorporated in the electronic-image recording apparatus. Further, when the electronic-image recording apparatus has a reproduction means that reproduces images obtained through photographing such as a liquid crystal display unit and an organic EL, the reproducing time of the reproduction means may be the prescribed condition. As a method to make it impossible to photograph, there are given a method to prevent a release button of an electronic-image recording apparatus from being pressed, a method to prevent a power supply for an electronic-image recording apparatus from being turned on, and a method to make a storage means to be unable to store images. It is preferable that a restriction means has MPU (Micro Processing Unit) or CPU (Central Processing Unit), capable of executing a program relating to restriction of photographing. The restriction means may also have a customized LSI in which a program is incorporated in advance, or a gate array. The restriction means may also be one that conducts mechanical restriction without conducting electronic restriction.

Further, the electronic-image recording apparatus may also have an output restriction means which outputs the first image information in the electronic-image recording apparatus only when the prescribed output condition is satisfied. In other words, it is preferable that the output of the first image signal stored in the electronic-image recording apparatus to the outside is restricted. Due to this, it is prevented that a user outputs images personally, which is preferable because circulation of electronic-image recording apparatuses can be promoted. It is also preferable on the point that a privacy of a user can be protected. It is preferable that the output restriction means has MPU (Micro Processing Unit) or CPU (Central Processing Unit), capable of executing a program relating to restriction of photographing. The restriction means may also have a customized LSI in which a program is incorporated in advance, or a gate array. For example, there may be given that restriction of output is released only when specific ID information, key words or electric signals are inputted. The restriction means may also be one that conducts mechanical restriction without conducting electronic restriction. For example, there may be given that the surface of a terminal for outputting to the outside is covered by a cover which cannot be opened unless a specific key is used.

A releasing means of the invention has only to be a means which can release the aforesaid restriction for photographing given by the restriction means of the electronic-image recording apparatus. For example, it is represented by one which releases the restriction for photographing given by the restriction means, by means of input of the specific password (one password, or combination of plural passwords, etc.), giving of the specific electric signal, replacement of the specific part and various mechanical means (pressing the specific switch, or twisting the specific switch by a key, specific operations for plural switches). It is also possible to combine plural operations mentioned above. It is preferable that a releasing means has MPU (Micro Processing Unit) or CPU (Central Processing Unit), capable of executing a program relating to releasing of the restriction for photographing. The releasing means may also have a customized LSI in which a program is incorporated in advance, or a gate array. For example, there is given that the restriction for photographing is released by inputting specific ID information, password, or electric signals. The releasing means may also be one that releases the restriction for photographing mechanically without controlling electronically.

As a first image signal in the invention, there is given a digital signal resulted from a simple A/D conversion of an analog signal from CCD or CMOS, or a digital signal resulted from a compressing process of the digital signal, or a digital signal resulted from a enciphering process of the digital signal, or a digital signal resulted from compressing and enciphering processes of the digital signal. Further, it is desirable that the format of the first image signal is different from a general-purpose data format, so that the general public cannot read the first image signal. As a second image signal, there is given an image signal based on general-purpose data format such as JPEG, Exif, bmp, cpt, gif, Jpq, pcd, pct, pic, pict, psd, tif, tif, or tiff. Incidentally, the data format of image signals employed by a plurality of companies can be considered as a general-purpose data format. For instance, it is applicable that an image signal, to which an analogue-to-digital conversion is applied, is stored in the memory means of the electronic-image recording apparatus and the reading means reads the image signal as the first image signal. Alternatively, it is also applicable that an image signal, being an analogue signal, is stored in the memory means of the electronic-image recording apparatus as it is, and, when the reading means reads the image signal, an analogue-to-digital converter of the electronic-image recording apparatus converts the image signal to a digital image signal to read the digital image signal as the first image signal.

As a conversion means of the invention (hereinafter referred to also as a processing means), there is given a means to convert the digital signal resulted from a simple A/D conversion of an analog signal into an image signal based on a general-purpose data format such as JPEG or Exif. Further, it is desirable that, when an enciphering operation is applied to the first image signal, the conversion means decodes the first image signal, and, when a compression processing is applied to the first image signal, the conversion means conducts a defrosting (an expansion) processing of the first image signal. It is preferable that the conversion means has MPU (Micro Processing Unit) or CPU (Central Processing Unit), capable of executing a program relating to conversion of an image signal. The conversion means may also have a customized LSI in which a program is incorporated in advance, or a gate array.

Further, the conversion means may also have an image processing means (hereinafter referred to also as a processing means) which conducts various image processing such as color conversion and luminance conversion, and data compression or data expansion, based on the second image signal. Incidentally, the second image signal includes an image signal which has been subjected to various image processing such as color conversion and luminance conversion.

It is preferable that the read-out means of the invention has an input terminal through which the information of an electronic-image recording apparatus can be inputted. This input terminal may also be arranged to be capable of being connected directly with an output terminal of the electronic-image recording apparatus. It is also possible to arrange so that information of the electronic-image recording apparatus can be inputted on the wireless system by the use of infrared rays or electric waves. The read-out means It is preferable that the read-out means has MPU (Micro Processing Unit) or CPU (Central Processing Unit), capable of executing a program relating to reading of the image signal. The read-out means may also have a customized LSI in which a program is incorporated in advance, or a gate array.

When the electronic-image recording apparatus has an output restriction means and output of the first image signal stored in the electronic-image recording apparatus to the outside is restricted, it is preferable that output of the first image signal to the outside is conducted only by the read-out means. In other words, it is preferable that the read-out means has an output restriction releasing means that releases the restriction for the output of the first image signal to the outside. The restriction of output of the first image signal is released by the output restriction releasing means through input of the specific password, giving of the specific electric signal and various mechanical means (pressing the specific switch, twisting the specific switch by a key and others). In the electronic-image recording apparatus, when output of the first image signal to the outside is restricted, it is possible to repress that image data are taken out freely at the user side, and thereby to conduct recovery of electronic-image recording apparatuses efficiently. It is further preferable that the output restriction releasing means has MPU (Micro Processing Unit) or CPU (Central Processing Unit), capable of executing a program relating to releasing output restriction. The output restriction releasing means may also have a customized LSI in which a program is incorporated in advance, or a gate array. The output restriction releasing means may also be an output restriction releasing means that releases the output restriction mechanically in place of electronically.

The output restriction releasing means may also have a display means (hereinafter referred to also as a processing means) that displays images based on the second image signal or displays other information. For example, there are given a liquid crystal display device, CRT display, a plasma display and organic EL display. It is preferable that the display means is provided in an apparatus in which a read-out means and a conversion means are provided integrally. However, the invention is not limited to that.

The output restriction releasing means may also have a transmission means (hereinafter referred to also as a processing means) that transmits image information and other information to a computer or a server, based on the second image signal. It is preferable that the transmission means is provided in an apparatus in which a read-out means and a conversion means are provided integrally. However, the invention is not limited to that.

The output restriction releasing means may also have a receiving means that receives information from an outer computer or server, which makes it possible to conduct remote manipulation.

It is preferable that there is provided an electronic-image recording apparatus processing means (hereinafter referred to also as a processing means) that conducts prescribed processing for reuse of the electronic-image recording apparatus.

When prescribed processing (for example, inspection) for reuse of the collected electronic-image recording apparatus is conducted by the electronic-image recording apparatus processing means, it is possible to judge reusable parts, which makes it possible to provide a low cost image forming apparatus more efficiently.

The electronic-image recording apparatus processing means (processing section) can be any of a means to conduct function inspection of an electronic-image recording apparatus, a means to change ID information stored in an electronic-image recording apparatus,

a means to initialize an electronic-image recording apparatus,

a means to erase information stored in the storage means of an electronic-image recording apparatus, a means to replace unusable parts or worn-out parts, a means to charge when an electronic-image recording apparatus has a power supply which can be charged, and a combination of the foregoing. It is preferable that the electronic-image recording apparatus processing means has MPU (Micro Processing Unit) or CPU (Central Processing Unit), capable of executing a program relating to the aforesaid various processing of the electronic-image recording apparatus. The electronic-image recording apparatus processing means may also have a customized LSI in which a program is incorporated in advance, or a gate array. It is preferable that a means to conduct processing of an electronic-image recording apparatus mechanically is also provided.

The electronic-image recording apparatus processing means may be either a solid apparatus wherein a read-out means, a conversion means and a releasing means are incorporated solidly, or a separate apparatus. For example, there are given a system having two separate apparatuses; one is a processing apparatus for reuse having therein a releasing means and an electronic-image recording apparatus processing means, and the other is a processing apparatus having therein a read-out means and a conversion means, a system having two separate apparatuses; one is a processing apparatus for reproduction having an electronic-image recording apparatus processing means, and the other is a processing apparatus for reuse having therein a read-out means, a conversion means and a releasing means, and a system representing a processing apparatus for reuse having therein all of an electronic-image recording apparatus processing means, a read-out means, a conversion means, and a releasing means.

Further, it is preferable that a recording means (hereinafter referred to also as a processing means) that records image information on an image recording medium based on the second image signal.

The recording means may either be a printer to record image information on an image recording medium such as a sheet of paper as a visible image, or be a recording apparatus that records image information on an image recording medium, such as FD, CD-R, CD-RW, MO, MD, DVD-R and DVD-RW, as digital information. As a printer, any of printers of an ink-jet system, silver halide photograph print system, a thermal printer system and an electrophotographic system can be used.

The recording means may be either a solid apparatus wherein a read-out means, a conversion means, a releasing means and an electronic-image recording apparatus processing means are incorporated integrally, or a separate apparatus.

It is preferable that there is provided a notifying means for photographable state (hereinafter referred to also as a notifying means) which notifies that the number of recording of images is not more than the prescribed number, when the number of recording of images recorded in the electronic-image recording apparatus is not more than the prescribed number.

It is preferable that the notifying means for photographable state is a means to notify that the number of recording of images is not more than the prescribed number, by means of an alarm, a voice or an image display.

The notifying means for photographable state may be either a solid apparatus wherein a read-out means, a conversion means, a releasing means, an electronic-image recording apparatus processing means and a recording means are incorporated integrally, or a separate apparatus. It is preferable that at least the notifying means for photographable state and the read-out means are incorporated integrally in a solid apparatus.

Further, it is also possible to arrange so that there are provided an insertion means into which an electronic-image recording apparatus can be inserted, and a keeping means which makes it possible to keep the electronic-image recording apparatus from which the first image information has been read out by the read-out means so that a person other than the prescribed person can not take out the electronic-image recording apparatus.

In this structure stated above, when an electronic-image recording apparatus is just set in an insertion section of the recovery apparatus by a user who has finished photographing by using the electronic-image recording apparatus, for example, the desired processing can be conducted, and then, the electronic-image recording apparatus is recovered, thus, the electronic-image recording apparatus can be recovered efficiently without troubling a user or a person who recovers. Incidentally, the prescribed person means a worker in a photofinisher who is qualified to recover an electronic-image recording apparatus, a worker in a maker or a person who is entrusted with recovery.

With regard to the insertion means, though the example of the invention explained later shows an example wherein a part of a read-out means is provided in an insertion means, the invention is not limited to this, and it may also be one like a hole section into which an electronic-image recording apparatus can simply be inserted.

As a keeping means, there are given a box with a key and a box which can be opened by input of specific information such as a specific password or ID information.

The insertion means and the keeping means may either be provided in a solid apparatus wherein other means are incorporated integrally, or be provided in a separate apparatus. Incidentally, it is preferable that the insertion means, the keeping means, the read-out means and the conversion means are incorporated in a solid apparatus. For example, an electronic-image recording apparatus recovery apparatus having therein an insertion means, a keeping means, a read-out means and a conversion means is given as a preferable example.

It is also possible to make a read-out means to be further housed in or connected with the recovery apparatus mentioned above. It is further possible to make a display means that displays images recorded in an electronic-image recording apparatus to be housed in or connected with the recovery apparatus mentioned above. Due to this, it is possible for a user to confirm images resulted from photographing by an electronic-image recording apparatus, and thereby to order prints for only necessary images. It is also possible to make the recovery apparatus to further house therein a transmission means that transmits image information based on the second image signal to an external computer or a server. This makes an image forming apparatus connected to the external computer or server to print highly detailed images.

Incidentally, it is preferable that there is provided an ejection means that ejects an electronic-image recording apparatus to the outside when the first image signal cannot be read out of the electronic-image recording apparatus or when the first image signal does not exist in the electronic-image recording apparatus, under the condition that the first image signal is read out properly by the read-out means and exposable frames still remain in the electronic-image recording apparatus. Due to this ejection means, it is possible to reject recovery of an electronic-image recording apparatus that malfunctions. Further, even when a user sets an unused electronic-image recording apparatus accidentally in the recovery apparatus, the ejection means can prevent that this unused electronic-image recording apparatus is recovered with reluctance.

It is further preferable to make the recovery apparatus to have a display means which displays, when the first image signal cannot be read out properly from an electronic-image recording apparatus, that the first image signal cannot be read out properly from the electronic-image recording apparatus.

Incidentally, an insertion inlet of the insertion means may either serves for an ejection outlet of the ejection means, or is separate from an ejection outlet of the ejection means.

Further, when reuse of the electronic-image recording apparatus is not desired or when the number of exposable frames is zero and all of the first image signals have been read out properly from the electronic-image recording apparatus under the condition that the first image signal is read out properly by the read-out means and exposable frames still remain, it is preferable that the electronic-image recording apparatus is kept by the keeping means.

Further, it is preferable that there is provided a rereading restriction means that makes it impossible to reread the first image signal from an electronic-image recording apparatus, when reuse of the electronic-image recording apparatus is not desired or when the number of exposable frames is zero and all of the first image signals have been read out properly from the electronic-image recording apparatus, under the condition that the first image signal is read out properly by the read-out means and exposable frames still remain. Due to this, it is possible to prevent an illegal use of image information, and to attain protection of privacy. It is preferable to indicate by a display means or to notify by a notifying means that rereading is made impossible by the rereading restriction means. When rereading of the electronic-image recording apparatus is restricted by the rereading restriction means, it is preferable that the restriction cannot be released even by the aforesaid output restriction releasing means.

Incidentally, it is preferable that a counting means that counts the number of electronic-image recording apparatuses kept in the keeping section and a counted value notifying means that notifies the counted value are provided. The counted value notifying means may also be arranged so that it notifies when the counted value reaches the prescribed value. The counted value notifying means can further be arranged so that it transmits information to an external computer or server through the transmission means.

An accounting processing means may further be provided. Accounting processing is to collect from a user a charge for an electronic-image recording apparatus to be provided again, a charge for a print or for recording on a digital information recording medium, and a charge for replacement of worn-out parts. It is preferable that the accounting processing means has therein at least one of a means to accept payment by cash (preferably having a scanner, a sensor to sense weight, a sensor to sense a size and a sensor to sense roughness), a reader for a credit card, a reader for a prepaid card, a reader for a debit card, a payment unit for payment service of a cellular phone and a unit for accepting payment by payment service of the Internet.

There may be provided a condition setting means that makes the electronic-image recording apparatus restricted by a restriction means in terms of photographing to be in the prescribed photographable state in accordance with accounting processing, after the prescribed accounting processing has been conducted by the accounting processing means. In other words, it is possible to release restriction of the electronic-image recording apparatus restricted in terms of photographing in accordance with accounting processing, and to return the electronic-image recording apparatus to its initial state, so that reuse is made to be possible. In this case, it is preferable that the electronic-image recording apparatus which has been made possible to be used again is ejected out of an ejection means. In this case, function inspection may also be conducted together. Owing to this, when an electronic-image recording apparatus is just set in an insertion section of the recovery apparatus by a user who has finished photographing by using the electronic-image recording apparatus, for example, the prescribed accounting processing is conducted by an accounting processing means, and the electronic-image recording apparatus is made to be in the photographable state by the condition setting means to be provided to a user again, thus, the electronic-image recording apparatus can be provided again efficiently without troubling a user or a maker. The releasing means mentioned above may also serve for a part or the whole of the condition setting means.

An example of an electronic-image recording apparatus which is preferable for the invention will be explained as follows. The electronic-image recording apparatus has therein a photoelectric conversion means, a storage means and a means to output to the outside for outputting the stored image signal to the outside. An image processing means that conducts image processing for the image signal to be outputted to the outside can be mounted on and dismounted from the means to output to the outside of the electronic-image recording apparatus. Namely, the image processing means is not always essential for recording an image signal, and the image processing means has only to function when the image signal stored in the storage means, for example, is outputted to the outside to be used.

In the invention, therefore, it is possible to sell an electronic-image recording apparatus by removing an image processing means, by making the image processing means to be capable of being mounted on and dismounted from the electronic-image recording apparatus, and thereby, it is possible to simplify the structure of the electronic-image recording apparatus to be sold and thereby to make it to be inexpensive. An image signal to be stored in a storage means may be either an analog signal from CCD, for example, or a digital signal obtained by A/D converting the analog signal.

Further, if an image signal erasing means for erasing at least a part of the stored image signal is provided, this image signal can be erased in case of need, which is convenient.

In general, an electronic camera is equipped with LCD which can reproduce images resulted from photographing, and it is necessary to conduct processing such as color conversion, for displaying image signals on LCD. On the contrary, if an electronic camera is not equipped with LCD so that image signals stored are outputted to the outside without being subjected to image reproduction processing, for example, the structure can be made simple and inexpensive.

Further, if an arrangement is made so that transmission of image signals to an outer output means is conducted only when the prescribed output condition is satisfied, namely, for example, only when there is input of an ID number or a password, it is possible to prevent illegal transmission, which is preferable.

Further, it is preferable that the aforesaid image processing includes color conversion processing, to which, however, the invention is not limited.

In another example of an electronic image recording system of the invention, there are provided an electronic-image recording apparatus and an image processing apparatus that conducts image processing for image signals stored in a storage means of the electronic-image recording apparatus. Namely, when recording image signals, an image processing apparatus is not always essential, and it has only to function when image signals stored in a storage means, for example, are outputted to the outside to be utilized. In the invention, therefore, it is possible to make the image processing apparatus to be sold in the state of separate from the electronic-image recording apparatus, and thereby to make the electronic-image recording apparatus to be sold to be simple in structure and low in cost. It is naturally possible to sell a solid apparatus in which the image processing apparatus and the electronic-image recording apparatus are united integrally. As stated above, the system in the invention may be either a system including the electronic-image recording apparatus or a system that does not include the electronic-image recording apparatus.

Another preferable example of the electronic-image recording apparatus is one wherein a photoelectric conversion means and a storage means that stores the first image signal based on an electric signal are provided, the stored first image signal is read out, and a conversion means to convert the first image signal read out into the second image signal (hereinafter referred to also as an image conversion means) can be mounted on and dismounted from the electronic-image recording apparatus. Namely, when recording image signals, the image conversion means is not always essential, and conversion has only to be conducted when image signals stored in a storage means, for example, are outputted to the outside to be utilized. In the invention, therefore, it is possible to make the conversion means to be capable of being mounted on and dismounted from the electronic-image recording apparatus, and thereby to sell the electronic-image recording apparatus from which the conversion means is removed, thus, it is possible to make the electronic-image recording apparatus to be sold to be simple in structure and low in cost. Incidentally, the electronic-image recording apparatus is represented by one like an electronic camera that converts optical images, for example, into electric signals, to which, however, the invention is not limited. Further, image signals to be stored in the storage means may be either analog signals coming from CCD, for example, or digital signals resulted from A/D conversion of the analog signals.

Further, if the image conversion means has an image processing means, image processing can be conducted in the course of image conversion, which makes the electronic-image recording apparatus to be simple in structure.

Incidentally, it is preferable that the image processing means conducts color conversion processing, to which, however, the invention is not limited.

Another image recording system of the invention is one having therein an electronic-image recording apparatus and a processing apparatus provided with a read-out means that reads out the first image signal recorded in the electronic-image recording apparatus by sending and receiving signals with the electronic-image recording apparatus and with a conversion means that converts the first image signal read out into the second image signal. Namely, when recording image signals, the conversion means is not always essential, and conversion has only to be conducted when image signals stored in a storage means, for example, are outputted to the outside to be utilized. Therefore, as in the invention, it is possible to sell the electronic-image recording apparatus including, for example, neither read-out means nor image conversion means by making the read-out means and the image conversion means to be separate from the electronic-image recording apparatus, thus, it is possible to make the electronic-image recording apparatus to be sold to be simple in structure and low in cost.

Other image recording and reproducing system of the invention is one having therein an electronic-image recording apparatus, a processing apparatus provided with a read-out means that reads out the first image signal recorded in the electronic-image recording apparatus by sending and receiving signals with the electronic-image recording apparatus and with a conversion means that converts the first image signal read out into the second image signal, and an image recording apparatus that conducts image recording by using output from the processing apparatus. Namely, when recording image signals, the conversion means is not always essential, and conversion has only to be conducted when image signals stored in a storage means, for example, are outputted to the outside to be utilized for image recording. Therefore, as in the invention, it is possible to sell the electronic-image recording apparatus including, for example, neither processing apparatus nor image recording apparatus, by making the processing apparatus provided with a read-out means that reads out the first image signal recorded in the electronic-image recording apparatus by sending and receiving signals with the electronic-image recording apparatus and with a conversion means that converts the first image signal read out into the second image signal and the image recording apparatus that conducts image recording by using output from the processing apparatus to be separate from the electronic-image recording apparatus, thus, it is possible to make the electronic-image recording apparatus to be sold to be simple in structure and low in cost. Incidentally, the image recording apparatus is an apparatus having the recording means, and it includes an apparatus to store image data in a storage medium and a printer that prints an image based on image data.

Further, if there is provided an accounting means that conducts accounting processing in the prescribed mode, it is possible to demand a charge corresponding to the use of a user, which is convenient.

Further, if the accounting processing can be conducted in accordance with reading of the first image signal, it is possible to conduct rational accounting, which is preferable.

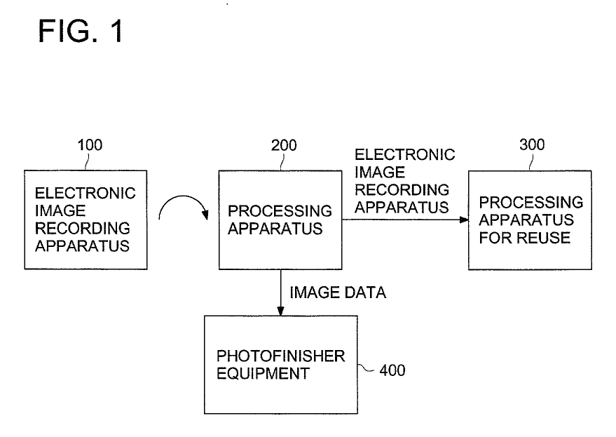

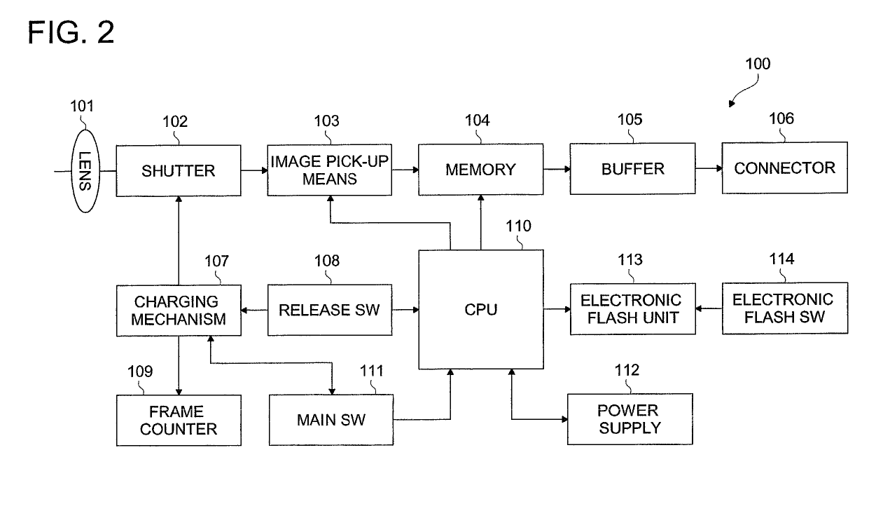

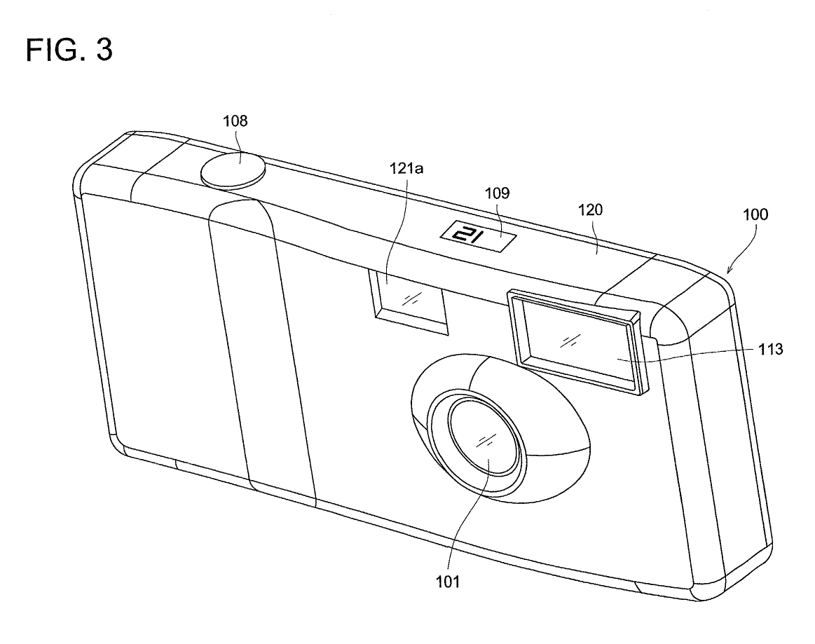

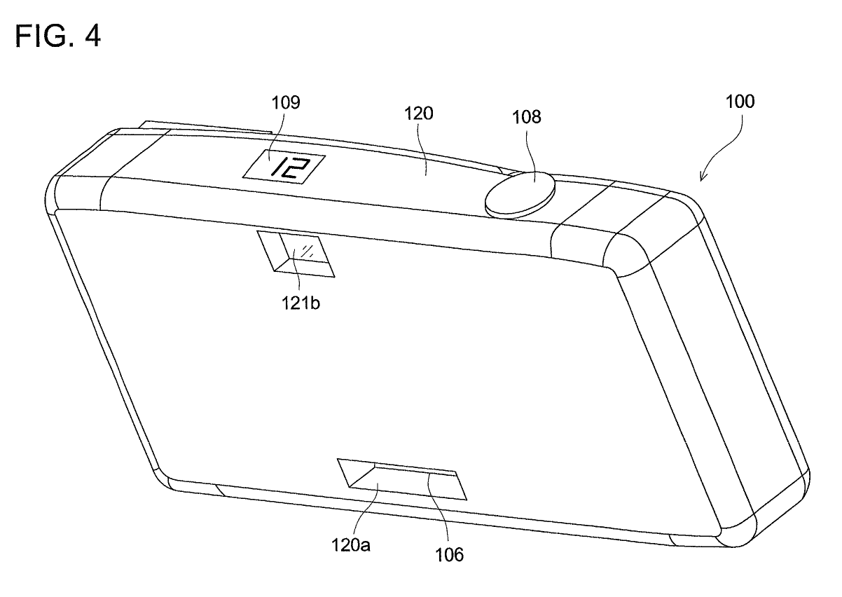

An embodiment of the invention will be explained as follows, referring to the drawings. FIG. 1 is a schematic diagram showing the total system related to the present embodiment, FIG. 2 is a block diagram of electronic still camera 100 relating to the present embodiment, FIG. 3 is a front view of the electronic still camera 100, and FIG. 4 is its rear view.

(First Embodiment)

A user uses an electronic-image recording apparatus, for example, electronic still camera 100 for photographing. When photographing is conducted under prescribed conditions, for example, when photographing is conducted for prescribed quantity, photographing is restricted, for example, it becomes impossible to photograph. As shown in FIG. 1, after the user takes the exposed electronic still camera 100 to a photofinisher, image signals stored in the electronic still camera 100 are read and converted into image data by processing apparatus 200. By using the image data obtained through conversion, it is possible to make prints on photofinisher equipment 400 having printing functions. Then, the electronic still camera 100 is taken in processing apparatus for reuse 300 where the restriction conducted earlier is released. Due to this, the electronic still camera 100 can be used again. In the processing apparatus for reuse 300, it is also possible to arrange so that parts and functions of the electronic still camera 100 may be inspected. The electronic still camera 100, the processing apparatus 200 and the processing apparatus for reuse 300 will be explained concretely as follows.

In the electronic still camera 100 shown in FIG. 2, when main switch 111 is turned on, electric power is supplied to CPU 110 from power supply 112 such as a battery, and image pick-up means (photoelectric conversion means) 103 such as CCD, memory 104 representing a recording means and electronic flash unit 113 are controlled by the CPU 110. The electronic flash unit 113 containing a capacitor for luminescence is arranged so that electric charging for luminescence may be started only when electronic flash switch 114 is turned on.

Further, when release switch 108 is turned on and charging mechanism 107 drives shutter 102 accordingly, image pick-up means 103 representing a photoelectric conversion means whose light-receiving surface is subjected to forming of an optical image by taking lens 101 through opened shutter 102 conducts the so-called photoelectric conversion for outputting analog signals corresponding to an optical image of a subject, under the control of CPU 110. As a photoelectric conversion means, it is possible to use a solid state image pick-up element such as CCD and CMOS. For obtaining images having high image quality, it is preferable that the number of pixels of the solid state image pick-up element is not less than 1,000,000, and the number ranging from 1000000 to 2000000 is more preferable when capacity of a memory to be used and circuits required in subsequent processing are taken into consideration. The analog signals obtained through the photoelectric conversion are recorded in memory 104 as they are or as digital signals (first image signals) obtained through A/D conversion. It is arranged so that the number of exposures is indicated on frame counter 109 corresponding to operations of the charging mechanism 107. The first image signals stored in memory 104 are outputted to the outside through buffer 105 and connector 106 under the control of CPU 110 representing a means to output to the outside. The CPU 110 makes ID number and the number of exposures to be stored in an internal memory. Electronic still camera 100 in the present embodiment is not provided with an image processing means, which makes the structure to be simple and inexpensive. Incidentally, though the first image signals stored in memory 104 can be outputted to the outside only when connecting to processing apparatus 200 which will be described later, input of the ID number, for example, may also be the condition for the output in this case. When photographing for the prescribed number of frames is finished, CPU 110 representing a restriction means can restrict photographing thereafter, independently of remaining capacity for storage of memory 104. Incidentally, it is also possible to arrange so that CPU 110 representing an image signal erasing means may erase only image information of the image resulted from the last photographing when an unillustrated erasure button is pressed.

In FIG. 3, electronic still camera 100 is covered entirely by camera body 120, and lens 101 is arranged at the center on the front side, while, lens 121a of a finder closer to a subject is arranged at the upper portion on the left side of the lens 101 and electronic flash unit 113 is arranged at the upper portion on the right side of the lens 101. Further, release switch 108 is arranged at the left portion on top of the electronic still camera 100 and frame counter 109 representing a reflection type liquid crystal panel is arranged at the center on the top.

In FIG. 4, eye piece 121b of a finder is arranged at the central upper portion on the rear side of the electronic still camera 100, rectangular opening 120a is formed on camera body 120 at the central lower portion on the rear side, and connector 106 is arranged at the back of the rectangular opening. Incidentally, since the connector 106 is specific in its shape, it can be connected only with signal reading device 201 of processing apparatus 200 described later or with processing apparatus for reuse 300, which prevents wrong reading and wrong releasing of restriction.

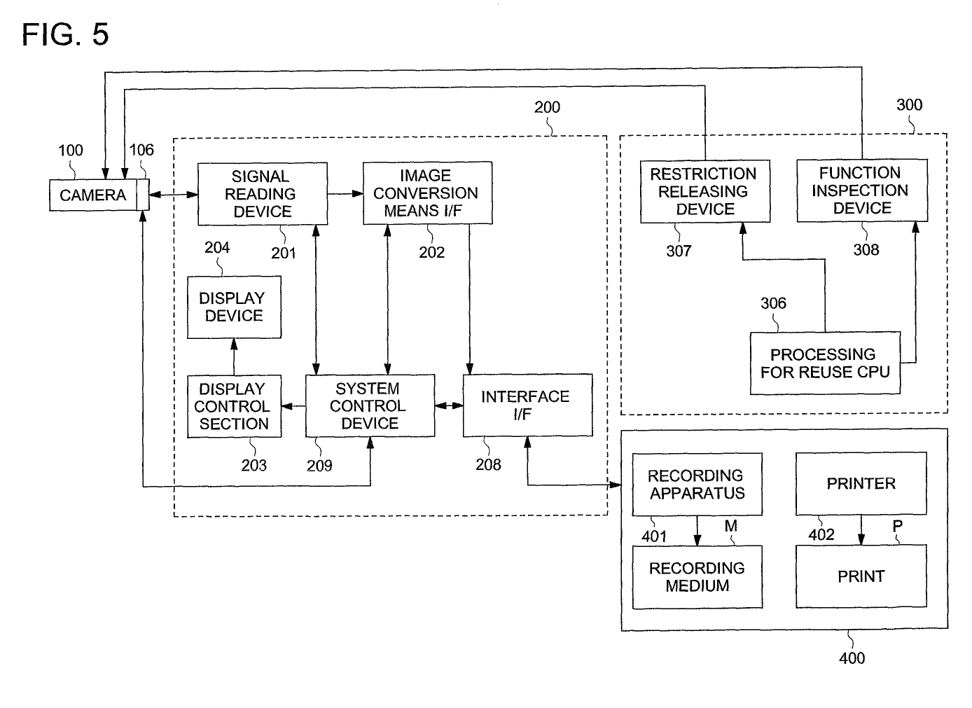

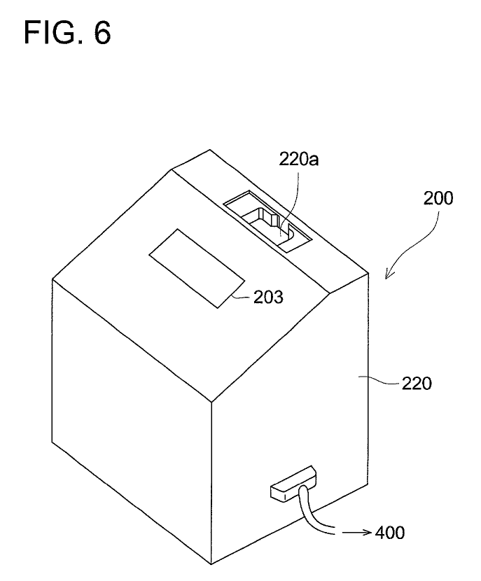

FIG. 5 is a diagram showing processing apparatus 200 and processing apparatus for reuse 300 which constitute a recycling system of an electronic still camera related to the present embodiment, and FIG. 6 is a perspective view of the processing apparatus 200. In FIG. 5, the processing apparatus 200 has therein signal reading device 201 that is connected with connector 106 of electronic still camera 100 and reads the first image signals, image conversion means 202 representing a conversion means that conducts prescribed image processing such as color conversion or compression (A/D conversion for analog signals) on image signals read out by signal reading device 201 and generates image data (second image signals) in a general purpose format such as JPEG, display control section 203 that drives display device 204 such as a liquid crystal panel to display, interface 208 such as USB and RS232C for conducting communication with external equipment, and system control device 209 that is connected to the foregoing to control them.

Further, processing apparatus for reuse 300 is arranged to be capable of being set so that it may be connected to electronic still camera 100, and it has processing for reuse CPU that controls the camera connected thereto. Further, photofinisher equipment 400 has therein recording apparatus 401 representing a recording means that records image data inputted from processing apparatus 200 through interface 208 on recording medium M such as CD-R or DVD-RAM, and printer 402 representing a recording means that generates print P by forming an image on a sheet of paper based on image data inputted in the same way.

On processing apparatus for reuse 300, there may be provided restriction releasing device 307 representing a releasing means that operates under the control of processing for reuse CPU 306 and releases the restriction concerning photographing with electronic still camera 100 and function inspection device 308 representing a processing means that conducts function inspection for electronic still camera 100. As a mode for restriction releasing, it is considered that CPU 110 makes it to be photographable state by input of specific password, but it is also possible, without being limited to the foregoing, to consider that the lock to prevent mechanically and electromagnetically a release switch of electronic still camera from being pressed is released. Processing apparatus for reuse 300 is installed in a maker.

In FIG. 6, processing apparatus 200 is covered entirely by casing 220 that is almost in a shape of a rectangular parallelepiped, and on its top, there is formed opening 220a that accepts electronic still camera 100. A cable to be connected to interface 208 extends toward photofinisher equipment 400 from the lower portion on the side of the processing apparatus 200.

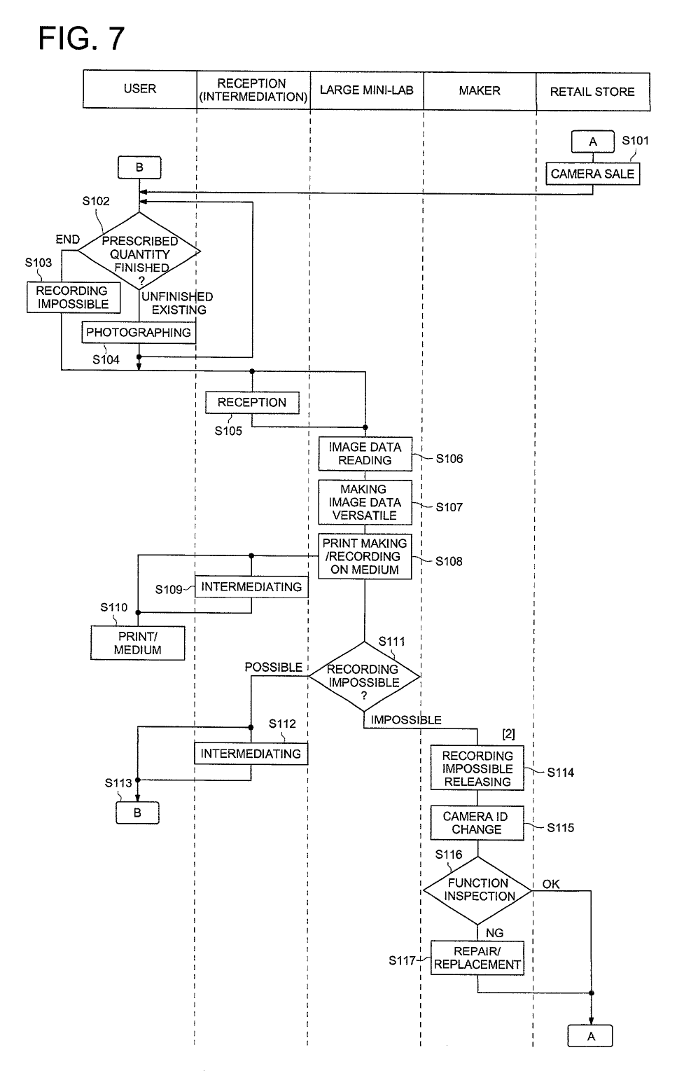

Next, operations of processing apparatus 200 relating to the present embodiment will be explained. FIG. 7 is a flow chart for illustrating the total system including operations of processing apparatus 200 relating to the present embodiment. The processing apparatus 200 is connected to photofinisher equipment 400, and storage in a storage medium or printing are conducted in the photofinisher equipment 400. The processing apparatus 200 is provided separately from processing apparatus for reuse 300. First, electronic still camera 100 produced by a maker is sold at a retail store as shown in step S101 to be handed to a user. At this point of time, the number of exposures is zero, and it is assumed that a user is informed in advance that photographing up to 24 frames, for example, is possible as an expiration date of the electronic still camera 100.

In step S102, CPU 110 of the electronic still camera 100 forms a judgment whether prescribed number of exposures (24 exposures in the present embodiment) have been covered or not. On this point of time, however, the number of exposures is zero, and CPU 110 judges that the prescribed number of exposures have not been covered accordingly, and allows a user to photograph in step S104, and further judges whether prescribed number of exposures have been covered or not (step S102). Incidentally, it is possible for a user to take or send the electronic still camera 100 to an intermediation store or a photofinisher before the prescribed number of exposures is covered.

On the other hand, when it is judged that the prescribed number of exposures has been covered, CPU 110 representing a restriction means controls image pick-up means 103 and prohibits photographing thereafter (step S103). In this case, if release switch 108 becomes impossible to be pressed or if frame counter 109 flashes, for example, a user can learn easily that photographing is not allowed, which is convenient.

Since it is impossible for a user to take out freely the first image signals obtained through photographing with electronic still camera 100 as stated above, the user is urged to take or send the electronic still camera 100 to an intermediation store or a photofinisher after the prescribed number of exposures has been covered. Now, as shown in step S105, when the electronic still camera 100 is taken to the intermediation store, prescribed order acceptance is conducted, and the electronic still camera 100 is sent to a photofinisher.

The electronic still camera 100 taken in a photofinisher is connected to processing apparatus 200, and the first image signals stored in memory 104 of the electronic still camera 100 are read through signal reading device 201 (step S106). These first image signals are subjected to prescribed image processing such as color conversion or compression in image conversion means 202 and image data in a general purpose format such as JPEG are generated (step S107).

In step S108, the second image signals generated in image conversion means 202 are sent to photofinisher equipment 400 through interface 208 depending on a user's request, to be recorded on recording medium M through recording apparatus 401 or print P is outputted on printer 402 based on the second image signals. This recording medium M and/or print P can be sent to the user or can be received by the user (step S110) through the intermediation store (step S109) or directly. Since the second image signals recorded on recording medium M are general purpose image signals in JPEG format, for example, a user can form freely with a personal computer as an image. Further, since the second image signals are recorded on recording medium M electronically, they are hardly deteriorated with a lapse of time, which makes it possible to obtain images with initial image quality at any time.

System control device 209 of processing apparatus 200 accesses CPU 110 through connector 106 of electronic still camera 100, and it can judge whether the prescribed number of exposures have been covered or not (step S111). In this case, it is also possible to make display device 204 representing a notifying means (photographable state notifying means) to display the number of remaining exposures in electronic still camera 100. When processing for reuse CPU 306 judges that photographing for remaining frames is possible because the prescribed number of exposures have not been covered, the electronic still camera 100 can be sent to a user or can be received by a user (step S113) through an intermediation store (step S112) or directly. After the user finishes photographing for remaining frames, the same step can be conducted.

On the other hand, when it is judged, in processing apparatus 200, that no more photographing can be carried out by electronic still camera 100 because prescribed number of exposures have already been finished, the electronic still camera 100 on which prescribed number of exposures have been finished is sent from a photofinisher to a maker. Then, CPU 110 of the electronic still camera 100 sent to a maker is accessed by processing apparatus for reuse 300, and restriction is released (step S114).

On the maker side, CPU 110 of the electronic still camera 100 received is accessed, and a camera ID number is changed to the new one (step S115). After that, functions of the electronic still camera 100 is inspected by function inspection device 308 of the processing apparatus for reuse 300 in step S116, and parts whose functions are deteriorated, if any, are repaired or replaced (step S117), then, the electronic still camera 100 is sold at a retail store again (step S101).

In the present embodiment, CPU 110 of the electronic still camera 100 representing a restriction means restricts photographing when the number of exposures made reaches a prescribed number, making it impossible to photograph, which makes a user to learn that an expiration date of the electronic still camera 100 has expired. On the other hand, the user is urged to take the electronic still camera 100 wherein no photographing is allowed to a photofinisher because it is impossible for the user to take out image data, which makes it possible to improve the collection rate of electronic still camera 100. Further, at a photofinisher or a maker to which electronic still cameras are collected, restriction releasing device 307 representing a restriction releasing means releases the restriction by CPU 110 to attempt reuse of necessary parts, and function inspection device 308 representing a processing means conducts a prescribed inspection for the reuse of the collected electronic still cameras, thus, it is easy to judge the parts which can be used again.

In addition to the function inspection processing for electronic still camera 100 and the processing to change ID information stored in CPU 110, the prescribed processing for the reuse includes processing for initializing CPU 110 of electronic still camera 100 and processing to erase contents stored in memory 104. Further, processing to replace the parts which are not usable, for example, is included, and charging processing is included when an electronic-image recording apparatus has a charging type battery. Further, it is also possible to install processing apparatus 200 at a maker.

Incidentally, the invention is not limited to the embodiment stated above, and it can naturally be changed or improved. For example, a prescribed condition for restricting photographing can also be a prescribed period of time from the start of photographing, in place of the prescribed number of exposures, and when an electronic still camera has therein a reproduction means such as LCD that reproduces images, the prescribed condition may also be a prescribed period of time for reproduction.

(Second Embodiment)

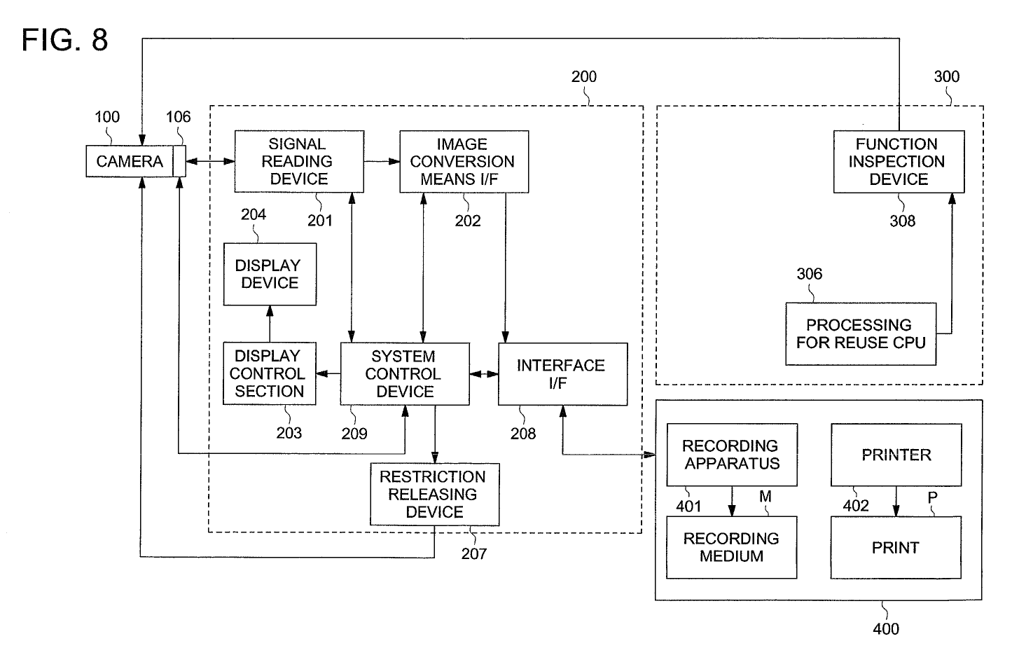

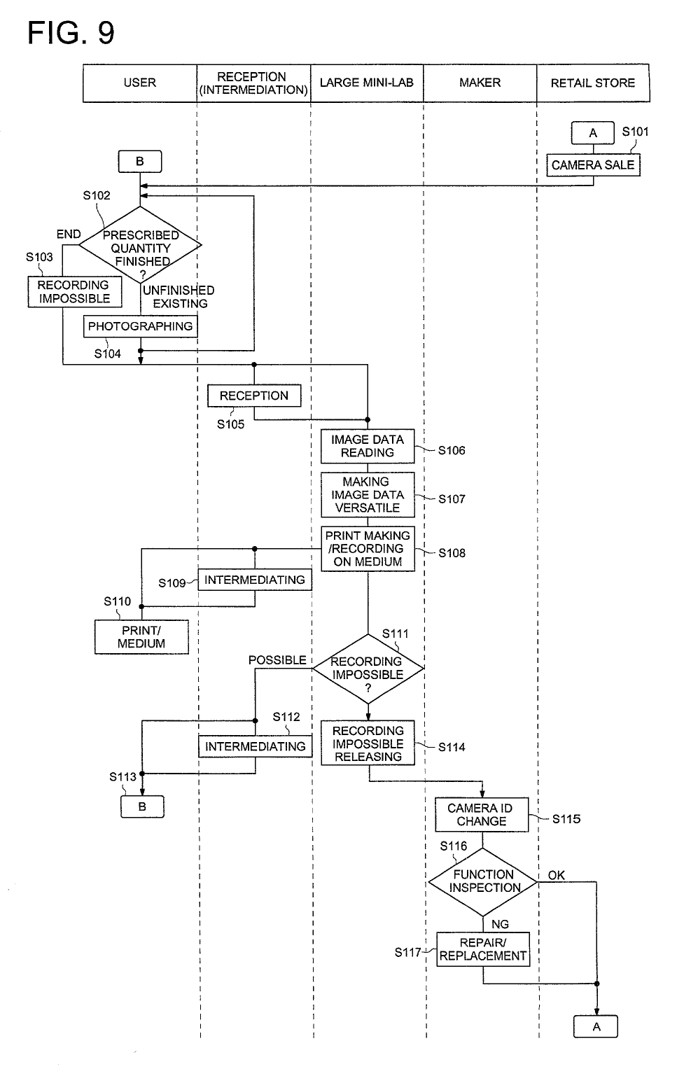

The second embodiment will be explained as follows, referring to FIGS. 8 and 9. Parts which are the same as those in the first embodiment will be omitted in terms of explanation.

FIG. 8 is a diagram showing processing apparatus for reuse 200 and reproduction processing apparatus 300 both constituting a recycling system for an electronic still camera relating to the present embodiment. In FIG. 8, processing apparatus for reuse 200 has therein signal readout section 201 representing a read-out means that is connected with connector 106 of electronic still camera 100 and reads out the first image signal, image conversion means 202 representing a conversion means that conducts prescribed image processing such as color conversion and compression (A/D conversion in case of analog signals) on image signals read out by the signal read-out section 201 and generates image data (second image signals) in the general-purpose format type such as JPEG, display control section 203 that drives display device 204 such as a crystal panel to conduct display, restriction releasing device 207 representing a releasing means that operates under the control of system control device 209 to release restriction relating to photographing by electronic still camera 100, interface 208 such as USB and RS232C for conducting communication with external equipment, and system control device 209 that is connected to the foregoing and conducts the control.

Further, reproduction processing apparatus 300 has therein user interface 301 that can conduct data transfer when connected with interface 208 of the processing apparatus for reuse 200 and reproduction processing CPU 306 that is connected to the foregoing to conduct control. Print system 400 has therein recording apparatus 401 representing a recording means that records image data inputted from processing apparatus for reuse 200 through interface 208 on recording medium M such as CD-R or DVD-ROM, and printer 402 representing a recording means that generates print P by forming images on paper based on image data inputted in the same way.

On the reproduction processing apparatus 300, there may be provided function inspection apparatus 308 representing a processing means (electronic-image recording apparatus processing means) that conducts function inspection for electronic still camera 100. As a mode for releasing the restriction, there is considered a method wherein input of specific password makes CPU 110 to be in the photographable state. However, the invention is not limited to this, and it is also possible to consider a method to release the locking that a release switch of electronic still camera 100 cannot be pressed mechanically and electromagnetically. The reproduction processing apparatus 300 is installed in a maker.

Next, operations of the processing apparatus for reuse 200 relating to the present embodiment will be explained. FIG. 9 is a flow chart for illustrating the total system including the processing apparatus for reuse 200 relating to the present embodiment. The processing apparatus for reuse 200 is connected with print system 400, and storage or printing on a storage medium is conducted by the print system 400. The processing apparatus for reuse 200 is provided to be separate from reproduction processing apparatus 300. First, electronic still camera 100 supplied from a maker is sold and handed to a user at a retail store as shown in step S101. At this point of time, the number of exposed frames is zero, and let it be assumed that a user is notified that photographing for 24 frames, for example, is possible as an expiration date of the electronic still camera 100.

CPU 110 of the electronic still camera 100 judges, in step S102, whether the prescribed number (24 frames in the present embodiment) of frames have been exposed or not, while, the number of exposed frames is zero at this point of time. Therefore, CPU 110 judges that the number of exposed frames is less than the prescribed number, and allows a user, in step S104, to photograph, and further judges whether the prescribed number of frames have been exposed or not after each photographing (Step S102). Incidentally, a user is allowed to take electronic still camera 100 to an intermediation store or a photofinisher before finishing the prescribed number of exposures.

On the other hand, when it is judged that the prescribed number of exposures have been finished, CPU 110 representing a restriction means controls image pick-up means 103 to prohibit photographing thereafter (step S103). In this case, if release switch 108, for example, becomes impossible to be pressed, or if frame counter 109 is made to flash, a user can learn easily that no photographing is allowed, which is convenient.

Since a user cannot take out freely the first image signal obtained through photographing by electronic still camera 100 as stated above, the user is urged, when finishing photographing for the prescribed number of frames, to take or consign the electronic still camera 100 to an intermediation store or a photofinisher. As shown in step S105, in this case, when the electronic still camera 100 is taken to the intermediation store, the prescribed order receiving is conducted, and the electronic still camera 100 is consigned to a photofinisher.

The electronic still camera 100 taken to the photofinisher is connected to processing apparatus for reuse 200, and the first image signal stored in memory 104 of the electronic still camera 100 is read out through signal readout section 201 (step S106). This first image signal is subjected to image processing such as color conversion or compression at the image conversion means 202 to be in the general-purpose format such as JPEG, and the second image signal is generated to be sent to print system 400 capable of printing based on digital signals, through interface 208 (step S107).

With regard to operations conducted at print system 400, the second image signal generated at image conversion means 202 is transmitted to print system 400 through interface 208 in step S108 to comply with demand of a user, so that the second image signal is recorded on recording medium M through recording apparatus 401, or print P is outputted by printer 402 based on the second image signal. Recording medium M and/or print P of this kind can be sent to or taken (step S110) by a user through an intermediation store (step S109) or directly. Since the second image signal recorded on recording medium M is an image signal of a general-purpose type such as JPEG format, a user can form freely with a personal computer as an image. Further, since the second image signal of this kind is recorded electronically on recording medium M, it is hardly deteriorated with the lapse of time. Therefore, images with fresh image quality can be obtained at any time.

Further, system control device 209 of processing apparatus for reuse 200 can access CPU 110 through connector 106 of electronic still camera 100 and can judge whether photographing for the prescribed number of Frames is finished or not (step S111). In this case, it is also possible to make display device 204 representing a notifying means (photographable state notifying means) to display the number of remaining photographable frames of electronic still camera 100. When reproduction processing CPU 306 judges that photographing for remaining number of frames is possible because the exposures for the prescribed number have not been finished, the electronic still camera 100 can be sent to or taken by (step S113) a user through an intermediation store (step S112) or directly. After the user finishes photographing for the remaining number of frames, the same step is executed.

On the other hand, when system control device 209 judges that no further photographing can be conducted by electronic still camera 100 because photographing for the prescribed number of frames has been finished, restriction releasing device 207 accesses CPU 110 of electronic still camera 100 to release the restriction (step S114). After that, the electronic still camera 100 wherein photographing for the prescribed number of frames has been finished is sent to a maker from a photofinisher.

On the maker side, CPU 110 of the electronic still camera 100 received by the maker is accessed by reproduction processing apparatus 300, and ID number is rewritten to the new one (step S115). After that, the electronic still camera 100 is subjected to inspection of functions by function inspection device 308 of the reproduction processing apparatus 300 in step S116, and parts whose functions have been deteriorated are subjected to repair/replacement (step S117) to be sold again at a retail store (step S101). When the reproduction processing apparatus 300 is installed at a photofinisher, it is also possible for the photofinisher to conduct function inspection for electronic still camera 100 to return it to a maker.

In the present embodiment, CPU 110 of electronic still camera 100 representing a restriction means restricts photographing when the number of exposed frames reaches the prescribed number of exposures so that photographing becomes impossible, which makes a user to learn that an expiration date of the electronic still camera 100 has expired. On the other hand, image data cannot be taken out freely on the user side, which urges the user to take the electronic still camera 100 which makes it impossible to photograph to a photofinisher, thus, collection rate of electronic still camera 100 can be improved. Further, at a photofinisher or a maker where the electronic still camera 100 is collected, restriction releasing device 207 representing a restriction releasing means releases the restriction of CPU 110 to attain reuse of necessary parts, and function inspection device 308 representing a processing means conducts the prescribed inspection for reuse of the collected electronic still camera, thus, it is possible to judge easily the parts which can be reused.

In addition to function inspection processing for electronic still camera 100 and processing to change ID information stored in CPU 110, processing to initialize CPU 110 of electronic still camera 100 and processing to erase contents stored in memory 104 are included in the prescribed processing for the reuse. Further, the prescribed processing for the reuse includes processing to replace parts which are not usable and also charging processing, when an electronic still camera has a charging type battery. Further, the processing apparatus for reuse 200 can also be installed in a maker.

Incidentally, the invention is not limited to the embodiment stated above, and it can naturally be varied and improved. For example, the prescribed condition to restrict photographing can be either the prescribed period of time from the start of photographing, or the prescribed reproduction time.

(Third Embodiment)

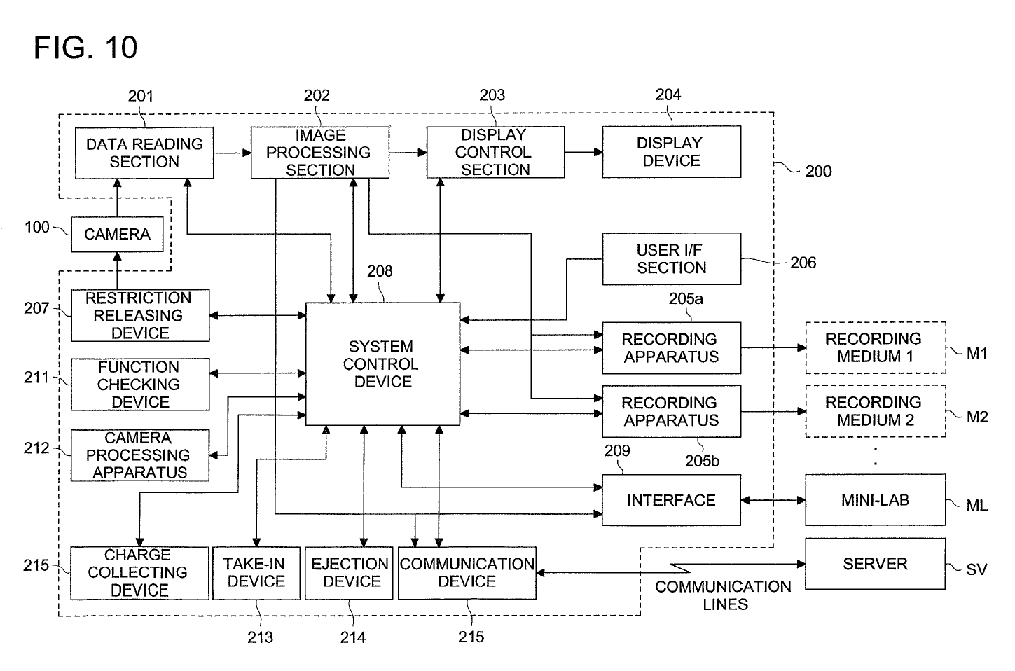

The third embodiment will be explained as follows, referring to FIGS. 10-14. For the parts which are the same as those in the first and second embodiment, explanation will be omitted.

Electronic still camera 100 of the present embodiment can be of the simple and inexpensive structure, because no image processing means is provided. Further, electronic still camera 100 of the present embodiment can be of the simple and inexpensive structure, because it has no LCD for image display, and it does not need to apply processing (color conversion and others) for recording and reproduction on image information stored in memory 104. The reason for the foregoing is that these processing can be conducted on the part of an external apparatus for displaying or printing images. Incidentally, though it is assumed that the first image signal stored in memory 104 representing a storage means can be outputted to the outside only in the case of connection with recovery apparatus 200 which will be explained later, it is possible, in that case, to make the input of information relating to certification such as, for example, ID number or a password to be the condition for output. As an electronic still camera, it is possible to use one that is the same as those in the first and second embodiment.

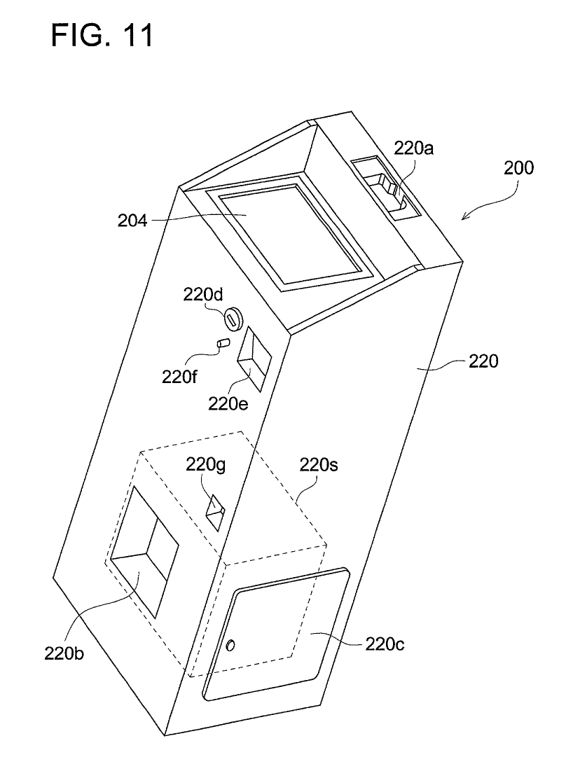

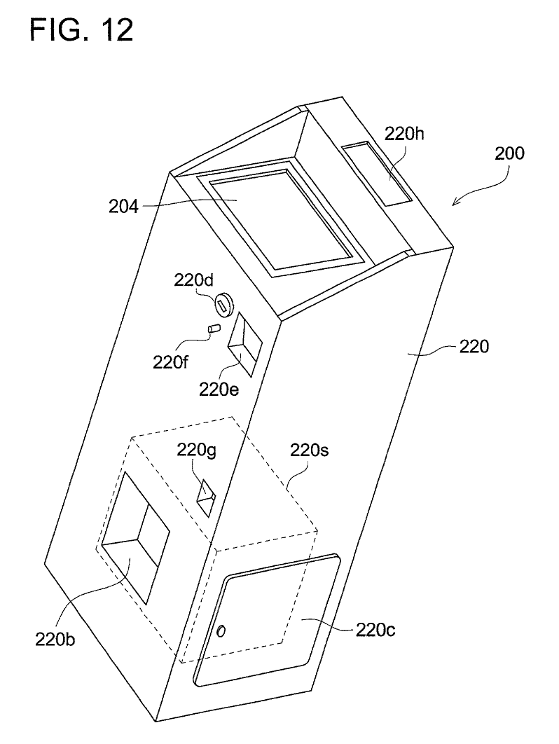

FIG. 10 is a diagram showing recovery apparatus 200 relating to the present embodiment, and each of FIGS. 11 and 12 represents its perspective view. A recovery system or recovery apparatus 200 is installed at, for example, a photofinisher or a convenience store, and it has a function to convert image information obtained through photographing by electronic still camera 100 into general-purpose format type and to write on a recording medium or to print as an image, and a function to recover electronic still camera 100.

In FIG. 10, the recovery apparatus 200 has therein data reading section 201 representing a read-out means that is equipped with a plug in a shape connectible to connector 106 of electronic still camera 100 and can read out analog signals, image processing section (processing means) 202 that converts analog signal, when the first image signal read out by the data reading section is an analog signal, into a digital signal, then, applies prescribed image processing such as color conversion or compression, and generates image data in the general-purpose format type such as JPEG, display control section (processing means) 203 that makes display device 204 representing a display means to display images based on the general-purpose image data, image recording apparatus (processing means) 205a that writes the general-purpose image data on recording medium M1 (for example, CD-R), image recording apparatus (processing means) 205b that prints visible images on recording medium (for example, print paper) based on the general-purpose image data, interface (processing means) 206 such as USB and RS-232C for communicating with outer computer Pc, restriction releasing device 207 that releases the restriction of electronic still camera 100, and system control device 208 that is connected to the foregoing and conducts controlling.

Further, the recovery apparatus 200 has therein interface 209 that makes it possible to transmit image data to mini-lab ML representing an image forming apparatus that is controlled by system control device 208 and can print highly detailed images, communication device (communication means and receiving means) 210 that makes it possible to transfer image data to or to receive image data from an outer computer or server SV capable of storing image data in large quantities, function checking device 211 that checks functions of electronic still camera 100, camera processing apparatus 212 representing an electronic-image recording apparatus processing apparatus that replaces and repairs parts which make functions of electronic still camera 100 to be inappropriate, take-in device 213 that takes in electronic still camera 100, ejection device 214 that ejects recording media M1 and M2, and charge collecting device 215.

In FIGS. 11 and 12, recovery apparatus 200 is covered entirely by casing 220, and on the top thereof, there are formed display device 204 composed of touch panel type LCD and insertion inlet (inserting section) 220a that accepts electronic still camera 100. As shown in FIG. 6, insertion inlet 220a is constituted to be covered freely by shutter 220h.

At the upper right portion on the front side of recovery apparatus 200, there are arranged coin insertion slot 220d constituting a part of collection device 215, bank note insertion inlet 220a, and return button 220f, while on the right portion from the center on the front side, there is arranged coin return shoot 220g.

At the lower portion on the front side of the recovery apparatus 200, there is formed ejection outlet 220b through which recording media M1 and M2 which have been finished in terms of recording are ejected. At the lower portion on the side of the recovery apparatus 200, there is formed door 220c of keeping deposit box (keeping means) 220s where electronic still camera 100 finished in terms of function inspection is kept. It is preferable that the door 220c is provided with a lock (not shown) which can be unlocked with a key only by a prescribed person.

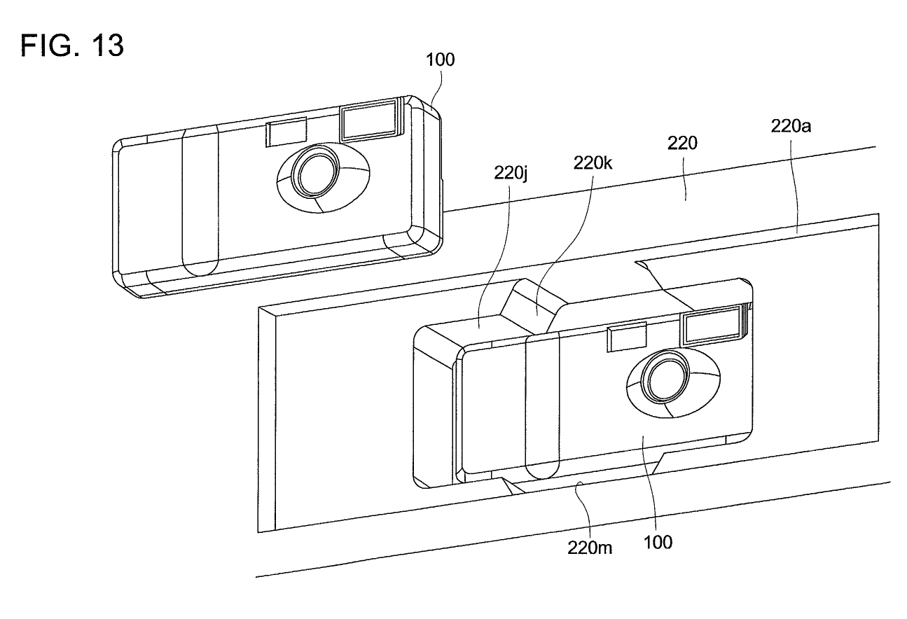

FIG. 13 is a diagram showing an enlarged insertion inlet 220a representing an insertion means. The insertion inlet 220a has recessed portion 220j whose shape is mostly the same as an external shape of electronic still camera 100, and on the recessed portion 220j, there are formed cutouts 220k and 220m which are located respectively on the rear side and on this side of the recessed portion, so that a user can grasp surely the electronic still camera 100 when inserting it in or taking it out of the insertion inlet 220a. Thus, troubles such as damage caused by dropping of the electronic still camera are suppressed.

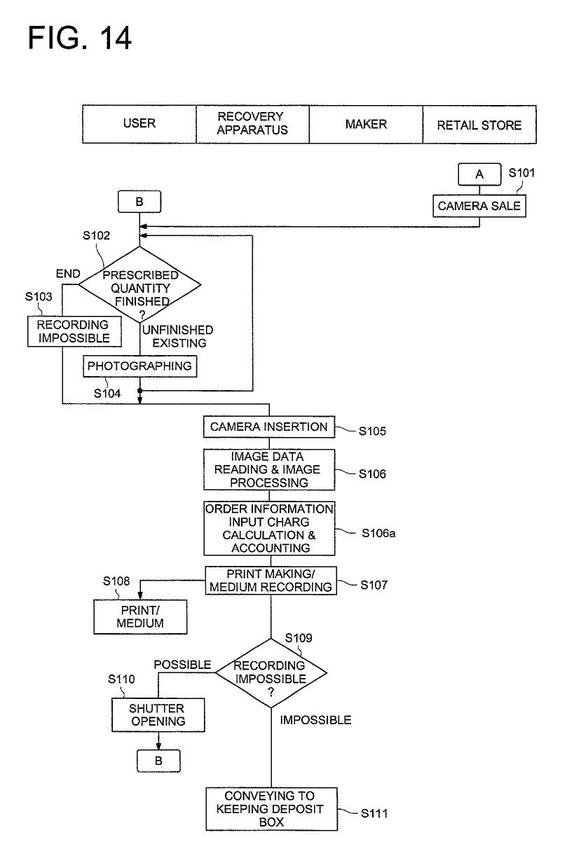

Next, operations of recovery apparatus 200 relating to the present embodiment will be explained. FIG. 14 is a flow chart for illustrating the total system including operations of the recovery apparatus 200 relating to the present embodiment. First, in FIG. 8, electronic still camera 100 supplied from a maker is sold at a retail store as shown in step S101 to be handed to a user. At this point of time, the number of exposed frames is zero, and let it be assumed that a user is notified that photographing for 24 frames, for example, is possible as an expiration date of the electronic still camera 100.

CPU 110 of the electronic still camera 100 judges, in step S102, whether the prescribed number (24 frames in the present embodiment) of frames have been exposed or not, while, the number of exposed frames is zero at this point of time. Therefore, CPU 110 judges that the number of exposed frames is less than the prescribed number, and allows a user, in step S104, to photograph, and further judges whether the prescribed number of frames have been exposed or not after each photographing (Step S102). Incidentally, a user is allowed to set the electronic still camera 100 on the recovery apparatus 200 before finishing the prescribed number of exposures.

On the other hand, when it is judged that the prescribed number of exposures have been finished, CPU 110 representing a restriction means controls image pick-up means 103 to prohibit photographing thereafter (step S103). In this case, if release switch 108, for example, becomes impossible to be pressed, or if frame counter 109 is made to flash, a user can learn easily that no photographing is allowed, which is convenient.

Since a user cannot take out freely the image data obtained through photographing by electronic still camera 100 as stated above, the user is urged, when finishing photographing for the prescribed number of frames, to set the electronic still camera 100 on recovery apparatus 200 installed in a photofinisher or a convenience store.

As shown in FIG. 13, the user can set the electronic still camera 100 in insertion inlet 220a of the recovery apparatus 200 whose shutter 220h is opened, while keeping the front side of the electronic still camera 100 to face upward (step S105). Due to this, data reading section 201 of the recovery apparatus 200 is connected with connector 106 of the electronic still camera 100, and data reading is made to be ready. Incidentally, after setting, shutter 220h is closed and the electronic still camera 100 is recovered. This prevents that electronic still camera 100 is taken out while data are read to cause an error.

System control device 208 is arranged to read out the first image signal stored in memory 104 of electronic still camera 100 through data reading section 201 of recovery apparatus 200 (step S106). When the first image signal is an analog signal, it is converted into a digital signal in image processing section 202, and it is subjected to prescribed image processing such as color conversion and compression, thus, image data in the general-purpose format type such as JPEG are generated.

In step S106a, there is inputted order information such as images from which a user desires prints and the number thereof, and charges for them are displayed on display device 204, or the charges are notified by a voice. Then, the user can pay the charges through coin insertion slots 220d and 220e.

In step S107, image data generated at image processing section 203 in accordance with user's requests inputted through display device 204 representing, for example, a touch-panel type display can be recorded on recording medium M1 (for example, CD-ROM) through recording apparatus 205a. This recording medium M1 can be offered (step S108) to the user through ejection outlet 220b. Since image data recorded on recording medium M1 are, for example, image signals of a general-purpose type such as JPEG format, a user can use them for forming images freely with a personal computer. Since these image data are recorded electronically on recording medium M, they are hardly deteriorated with the lapse of time, and images with initial image quality can be obtained at any time.

Further, in the same step S107, it is possible to print images on recording medium M2 (for example, print paper) through recording apparatus 205b, based on image data generated at image processing section 203 in compliance with user's requests inputted equally through display device 204. This recording medium M2 can be offered (step S108) to the user through ejection outlet 220b. Incidentally, when a user inputs a highly detailed image print through, for example, touch-panel type display device 204, image data are transmitted, through interface 209, to mini-lab ML where a highly detailed print can be outputted.

Further, system control device 208 of processing apparatus 200 can access CPU 110 through connector 106 of electronic still camera 100, and can judge whether or not image information has been recorded properly and photographing for a prescribed number of frames has been finished. In this case, it is also possible to make display device 204 to display the number of remaining exposures in electronic still camera 100. When control device 208 judges that photographing for remaining frames is possible because photographing for the prescribed number of frames has not been finished, the control device 208 can open shutter 220h (step s110) and can display on display device 204 a message “This is returned because remaining frames in quantity of can be used for photographing.” It is also possible to arrange so that shutter 220h is closed, take-in device 213 is driven, and electronic still camera 100 is moved to keeping deposit box 220s when there is inputted from display device 204 that a user does not desire to have its camera returned even when some frames remain unused.

On the other hand, when it is judged, in system control device 208, that no more photographing can be carried out by electronic still camera 100 because photographing for the prescribed number of exposures has already been finished, shutter 220h is not opened, and apparatus 213 is finally driven and the electronic still camera 100 is moved to keeping deposit box 220s (step S111).

It is further possible to arrange so that restriction releasing device 210 of processing apparatus 200 representing a releasing means accesses CPU 110 of electronic still camera 100 to erase image information stored in memory 104 and thereby makes rereading to be impossible and releases restriction for photographing.

In the present embodiment, when a user who has finished photographing with electronic still camera 100 just sets the electronic still camera 100 in insertion inlet 220a of recovery apparatus 200 installed in a corner of a photofinisher or a convenience store, desired processing can be carried out, and then, the electronic-image recording apparatus is recovered, thus, the electronic still camera 100 can be recovered efficiently without troubling a user or a person who recovers.

Incidentally, when it is impossible for data reading section 201 to read out image information properly from the electronic still camera 100, if shutter 220h of insertion inlet 220a is opened so that electronic still camera 100 set on recovery apparatus 200 may be ejected, it is possible to prevent recovery of electronic still camera 100 whose function is defective, which is preferable. When there is no image information, it is considered that a user has set unused electronic still camera 100 on recovery apparatus 200 by mistake. Therefore, if shutter 220h of insertion inlet 220a is opened equally and the electronic still camera 100 set on the recovery apparatus 200 is ejected out, the electronic still camera 100 turns out to be capable of being used by a user, which is preferable.

When it is impossible for electronic still camera 100 to read image information properly, if there is displayed on display device 204 that reading is impossible, the display makes a user to learn that the electronic still camera 100 might be defective in terms of functions, which is preferable.

Further, though it is arranged so that electronic still camera 100 is ejected out of an apparatus through insertion inlet 220a when unexposed frames remain in the camera, the electronic still camera 100 may also be ejected out of an apparatus through ejection outlet 220b that is different from insertion inlet 220a.

Incidentally, though system control device 208 representing a means to prohibit reading erases image information in memory 104 of electronic still camera 100, as processing to prohibit reading, to prevent illegal use of image information, it is preferable that this erasure is carried out after the image information is transferred to an outer computer or server SV. Further, if display device 204 displays thereon that processing to prohibit reading of image information has been carried out, by means of a display saying that “All pieces of image information in the memory have been erased”, it is possible to make a user feel easy.

When the number of electronic still cameras 100 kept in keeping deposit box 220s of recovery apparatus 200 is counted by system control device 209 representing a counting means, and when the counted value reaches the prescribed value, if the counted value is displayed on the display device 204 representing a notifying means, it is possible to transmit information necessary for recovery such as that the keeping deposit box 220s is full, which is preferable.

Further, when the recovery apparatus 200 is operating on an unmanned basis, if system control device 208 transmits counted value to an outer computer or server SV through communication device 210, the number of electronic still cameras 100 kept is known even at a remote place, which is convenient.

Further, if the system control device 208 representing a receiving means receives information from an outer computer or server, it is possible to conduct remote control, which is preferable.

Incidentally, the invention is not limited to the embodiment stated above, and it can naturally be varied and improved. In the present embodiment, it is also possible to arrange to provide a releasing means that releases a restriction means for an electronic-image recording apparatus and thereby to keep the electronic-image recording apparatus in a keeping means after releasing the restriction for photographing by a releasing means.

(Fourth Embodiment)

The fourth embodiment will be explained as follows, referring to the drawings. With regard to items which are the same as those in the first-third embodiment, explanation thereof will be omitted.

In the present embodiment, there is used processing apparatus 200 that is similar to that in FIG. 10 in the second embodiment.

Though the processing apparatus 200 is mostly the same as the recovery apparatus in FIG. 10 in the second embodiment, a condition setting means is composed of restriction releasing device 207, function checking device 211 and camera processing apparatus 212.

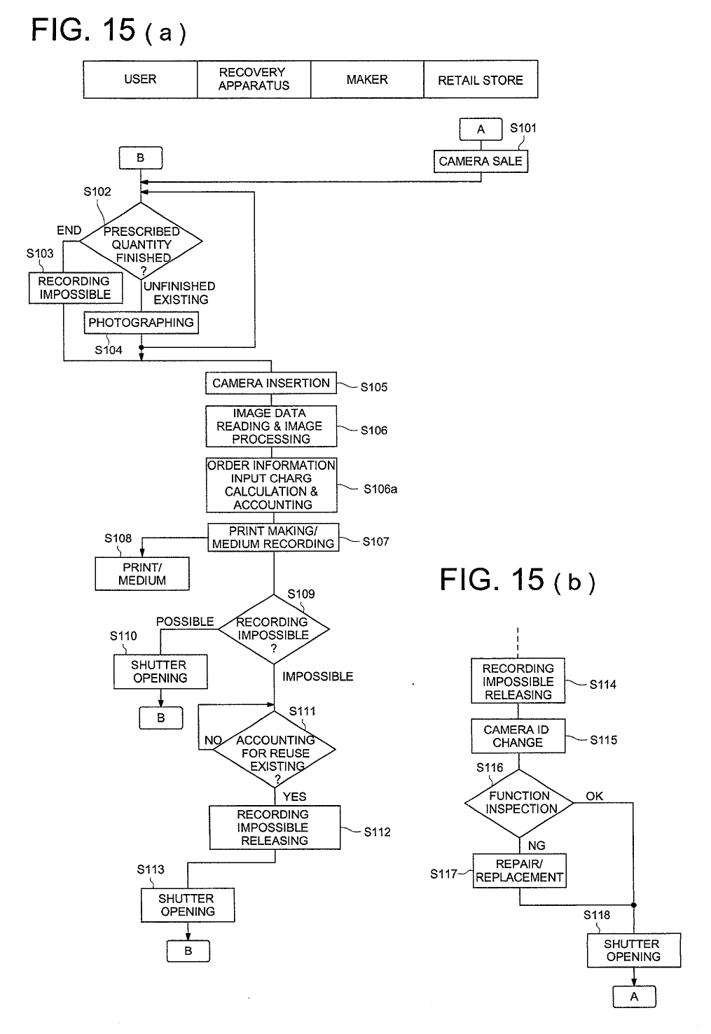

Next, operations of recovery apparatus 200 relating to the present embodiment will be explained. FIG. 15 is a flow chart for illustrating the total system including operations of the recovery apparatus 200 relating to the present embodiment. First, in FIG. 15(a), electronic still camera 100 supplied from a maker is sold at a retail store as shown in step S101 to be handed to a user. At this point of time, the number of exposed frames is zero, and let it be assumed that a user is notified that photographing for 24 frames, for example, is possible as an expiration date of the electronic still camera 100.

CPU 110 of the electronic still camera 100 judges, in step S102, whether the prescribed number (24 frames in the present embodiment) of frames have been exposed or not, while, the number of exposed frames is zero at this point of time. Therefore, CPU 110 judges that the number of exposed frames is less than the prescribed number, and allows a user, in step S104, to photograph, and further judges whether the prescribed number of frames have been exposed or not after each photographing (Step S102). Incidentally, a user is allowed to set the electronic still camera 100 on the processing apparatus 200 before finishing the prescribed number of exposures.

On the other hand, when it is judged that the prescribed number of exposures have been finished, CPU 110 representing a restriction means controls image pick-up means 103 to prohibit photographing thereafter (step S103). In this case, if release switch 108, for example, becomes impossible to be pressed, or if frame counter 109 is made to flash, a user can learn easily that no photographing is allowed, which is convenient.

Since a user cannot take out freely the image data obtained through photographing by electronic still camera 100 as stated above, the user is urged, when finishing photographing for the prescribed number of frames, to set the electronic still camera 100 on processing apparatus 200 installed in a photofinisher or a convenience store.

As shown in FIG. 13, the user can set the electronic still camera 100 in insertion inlet 220a of the processing apparatus 200 whose shutter 220h is opened, while keeping the front side of the electronic still camera 100 to face upward (step S105). Due to this, data reading section 201 of the processing apparatus 200 is connected with connector 106 of the electronic still camera 100, and data reading is made to be ready. Incidentally, after setting, shutter 220h is closed and the electronic still camera 100 is recovered. This prevents that electronic still camera 100 is taken out while data are read to cause an error.

System control device 208 is arranged to read out the first image signal stored in memory 104 of electronic still camera 100 through data reading section 201 of processing apparatus 200 (step S106). When the first image signal is an analog signal, it is converted into a digital signal in image processing section 202, and it is subjected to prescribed image processing such as color conversion and compression, thus, image data in the general-purpose format type such as JPEG are generated.

In step S106a, there is inputted order information such as images from which a user desires prints and the number thereof, and charges for them are displayed on display device 204, or the charges are notified by a voice. Then, the user can pay the charges through coin insertion slots 220d and 220e.

In step S107, image data generated at image processing section 203 in accordance with user's requests inputted through display device 204 representing, for example, a touch-panel type display can be recorded on recording medium M1 (for example, CD-ROM) through recording apparatus 205a. This recording medium M1 can be offered (step S108) to the user through ejection outlet 220b. Since image data recorded on recording medium M1 are, for example, image signals of a general-purpose type such as JPEG format, a user can use them for forming images freely with a personal computer. Since these image data are recorded electronically on recording medium M, they are hardly deteriorated with the lapse of time, and images with initial image quality can be obtained at any time.

Further, in the same step S107, it is possible to print images on recording medium M2 (for example, print paper) through recording apparatus 205b, based on image data generated at image processing section 203 in compliance with user's requests inputted equally through display device 204. This recording medium M2 can be offered (step S108) to the user through ejection outlet 220b. Incidentally, when a user inputs a highly detailed image print through, for example, touch-panel type display device 204, image data are transmitted, through interface 209, to mini-lab ML where a highly detailed print can be outputted.

Further, system control device 208 of processing apparatus 200 can access CPU 110 through connector 106 of electronic still camera 100, and can judge whether or not image information has been recorded properly and photographing for a prescribed number of frames has been finished. In this case, it is also possible to make display device 204 to display the number of remaining exposures in electronic still camera 100. When control device 208 judges that photographing for remaining frames is possible because photographing for the prescribed number of frames has not been finished, the control device 208 can open shutter 220h (step s110) and can display on display device 204 a message “This is returned because remaining frames in quantity of can be used for photographing.” When there is inputted from display device 204 that a user does not desire to have its camera returned even when some frames remain unused, shutter 220h is closed, take-in device 213 is driven, and electronic still camera 100 is moved to keeping deposit box 220s.

On the other hand, when it is judged, in system control device 208, that no more photographing can be carried out by electronic still camera 100 because normal image information is stored and photographing for the prescribed number of exposures has already been finished, it is judged in the step Sill whether accounting for reuse has been carried out or not. After appropriate accounting has been conducted by a user by paying displayed additional charge through coin inlet slot 220d and bank note insertion inlet 220e shown in FIGS. 5 and 6, restriction of photographing for electronic still camera 100 is released in step S112, and shutter 220h is opened in step S113. This makes reuse of electronic still camera 100 possible for a user.

On the contrary, when an additional charge is zero because a user does not desire image recording in step S111, it is possible to arrange so that electronic still camera 100 is not returned, and it conveyed to keeping deposit box 220s.

When a user desires reuse of electronic still camera 100, the electronic still camera 100 is set on processing apparatus 200. Then, system control device 208 representing an accounting processing means determines a charge for the reuse based on accounting processing, and display device 204 displays the charge. If the charge is collected from the user, restriction releasing device 210 of the processing apparatus 200 representing a releasing means accesses CPU 110 of the electronic still camera 100 to make rereading impossible by erasing image information stored in memory 104 and to make the electronic still camera 100 to be in the prescribed photographable state by releasing the restriction for photographing, thus, the electronic still camera 100 can be offered to the user again.

In a variation of the present example, an ID number in CPU 110 of the electronic still camera 100 is rewritten (step S115), following the step S113 of FIG. 14(a) in the processing apparatus 200, in FIG. 14(b). After that, the electronic still camera 100 is subjected to function inspection in step S116, and for parts whose functions are deteriorated, it is considered that they are repaired by camera processing apparatus 212 or replaced (step S117) and shutter 220h is opened (step S118) so that the electronic still camera 100 may be offered to a user.

Incidentally, though the example stated above employs a system wherein the used electronic still camera 100 is made to be in the reusable state by releasing the restriction for photographing when a charge is paid again, it is also possible to employ a system wherein a new electronic still camera or one released in terms of restriction, or further one inspected and repaired is kept in advance to be offered in accordance with accounting with a user.

In the present embodiment, a user who has finished photographing on electronic still camera 100 just sets the electronic still camera 100 in insertion inlet 220a of processing apparatus 200 installed at the corner of a photofinisher or a convenience store that is easy to access, then, system control device 208 conducts the prescribed accounting processing and the electronic still camera 100 is processed by camera processing apparatus 212 to be in the photographable state to be offered again, thus, the electronic still camera 100 can be offered efficiently without troubling a user or a maker.

Incidentally, when data reading section 201 cannot read image information properly from electronic still camera 100, it is preferable to open shutter 220h of insertion inlet 220a so that the electronic still camera 100 set on processing apparatus 200 may be ejected out, because it is prevented that the electronic still camera 100 having defective functions is offered again. When the data reading section 201 reads image information properly and there still remain photographable frames, if shutter 220h of insertion inlet 220a is opened so that the electronic still camera 100 set on processing apparatus 200 may be ejected out, a user can photograph for the remaining photographable frames, which is preferable. When the data reading section 201 reads image information properly and the prescribed accounting processing stated above is conducted, if shutter 220h of insertion inlet 220a is opened so that the electronic still camera 100 set on processing apparatus 200 may be ejected out, a user can receive reoffering of electronic still camera 100, which is preferable. If shutter 220h of insertion inlet 220a is opened so that the electronic still camera 100 set on processing apparatus 200 may be ejected out when there is no image information in electronic still camera 100, it is possible to prevent that electronic still camera 100 that is unused for photographing and is set on a processing apparatus erroneously by a user is recovered, which is preferable.

When image information cannot be read properly from electronic still camera 100, if display device 204 displays that no image information can be read, this display makes a user or an operator to learn that malfunction might be caused on the electronic still camera 100, which is preferable.

Further, electronic still camera 100 may be ejected out of an apparatus either through insertion inlet 220a or through ejection outlet 220b that is different from the insertion inlet 220a.

When a prescribed accounting processing conducted by system control device 208 is an accounting processing for initializing electronic still camera 100 to be in the photographable state, image information is properly read and the prescribed accounting processing is conducted, it is preferable to eject the electronic still camera 100 out after camera processing apparatus 212 conducts the processing to make the electronic still camera 100 to be in the initial state that is photographable state.

Further, if the processing to make electronic still camera 100 to be in the initial state wherein the electronic still camera 100 can be used for photographing includes function checking for the electronic still camera 100 conducted by function checking device 211, it is preferable because reoffering of electronic still camera 100 having defective functions can be prevented.

When data reading section 201 reads image information properly and there still remain photographable frames, and when reuse of the electronic still camera 100 is not desired, or when image information has been read properly out of the electronic still camera 100 and accounting processing for reusing the electronic still camera 100 is not conducted for a certain period of time, if electronic still camera 100 is made to be kept in keeping section 220s provided in an apparatus, it is preferable because electronic still cameras 100 which are not desired to be reused can be recovered efficiently. These are initialized again by a maker or a retail store, and can be offered to users.

Further, when image information is read properly out of electronic still camera 100 and there still remain photographable frames, and when reuse of the electronic still camera 100 is not desired by a user, or when image information has been read properly out of the electronic still camera 100 and prescribed accounting processing is not conducted, if there is conducted processing to make rereading of image information from the electronic still camera 100 to be impossible, it is preferable because illegal use of such image information can be prevented.

Incidentally, though system control device 208 erases image information in memory 104 of electronic still camera 100, as processing to prohibit reading, to prevent illegal use of image information, it is preferable that this erasure is carried out after the image information is transferred to an outer computer or server SV. Further, if display device 204 displays thereon that processing to prohibit reading of image information has been carried out, by means of a display saying that “All pieces of image information in the memory have been erased”, it is possible to make a user feel easy.

When the number of electronic still cameras 100 kept in keeping deposit box 220s of processing apparatus 200 is counted by system control device 209 representing a counting means, and when the counted value reaches the prescribed value, if the counted value is displayed on the display device 204 representing a notifying means, it is possible to transmit information necessary for recovery such as that the keeping deposit box 220s is full, which is preferable.

Further, when the processing apparatus 200 is operating on an unmanned basis, if system control device 208 transmits counted value to an outer computer or server SV through communication device 210, the number of electronic still cameras 100 kept is known even at a remote place, which is convenient.

Further, if the system control device 208 representing a receiving means receives information from an outer computer or server, it is possible to conduct remote control, which is preferable.

Incidentally, the invention is not limited to the embodiment stated above, and it can naturally be varied and improved. In the present embodiment, it is also possible to arrange to provide a releasing means that releases a restriction means for an electronic-image recording apparatus and thereby to keep the electronic-image recording apparatus in a keeping means after releasing the restriction for photographing by a releasing means.

(Fifth Embodiment)

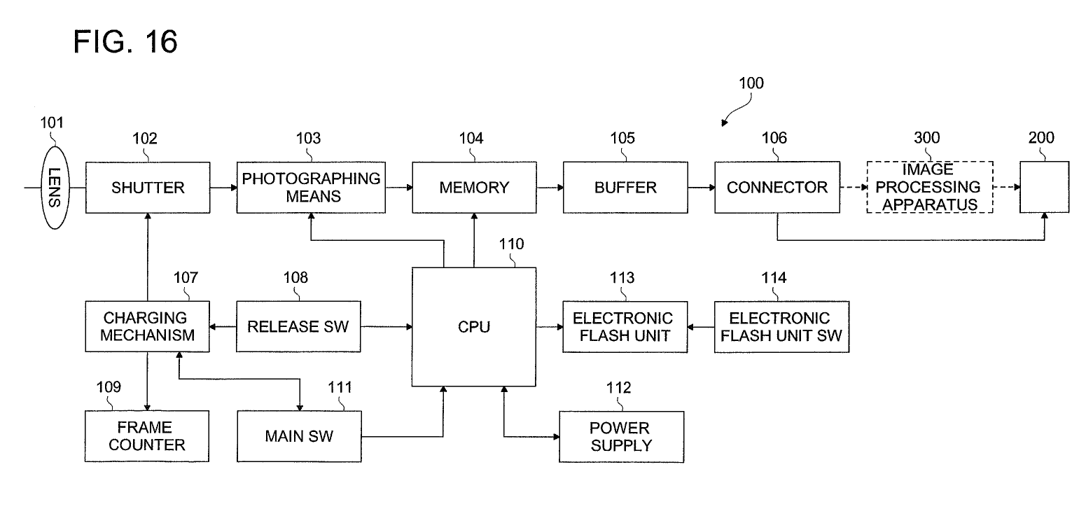

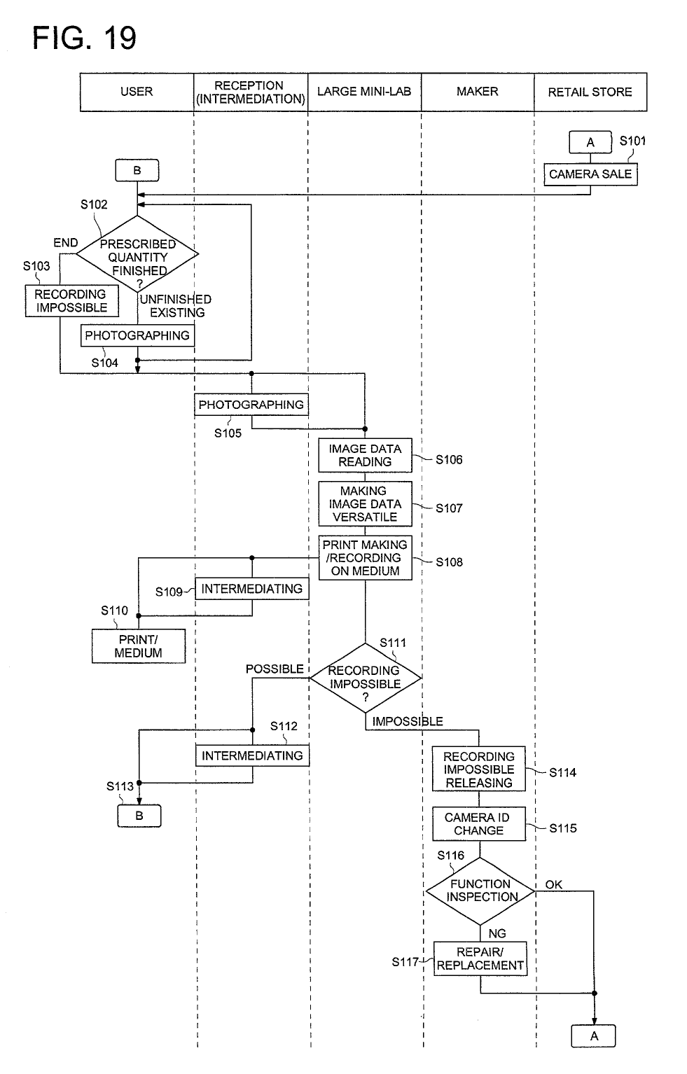

The fifth embodiment will be explained as follows, referring to FIGS. 16-19. FIG. 19 is a block diagram of electronic still camera 100 related to the present embodiment. In the present embodiment, electronic still camera 100 constitutes an electronic still camera 100 apparatus, while, electronic still camera 100 and image processing section 203 of processing apparatus 200 constitute an electronic image recording system. With regard to items which are the same as those in the first embodiment-fourth embodiment, explanation thereof will be omitted.

In electronic still camera 100 shown in FIG. 16, CPU 110 is supplied with power from power supply 112 such as a battery when main switch 111 is turned on, and it controls image pick-up means 103 such as CCD and memory 104 representing a storage means and electronic flash unit 113. The electronic flash unit 113 containing a capacitor for luminescence is arranged so that electric charging of the capacitor for luminescence may be started only when electronic flash switch 114 is turned on.

Further, when release switch 108 is turned on and charging mechanism 107 drives shutter 102 accordingly, image pick-up means 103 representing a photoelectric conversion means whose light-receiving surface is subjected to forming of an optical image by taking lens 101 through opened shutter 102 conducts the so-called photoelectric conversion for outputting analog signals (first image signal) corresponding to an optical image of a subject, under the control of CPU 110. As an image pick-up means, it is possible to use a solid state image pick-up element such as CCD and CMOS which conduct photoelectric conversion. For obtaining images having high image quality, it is preferable that the number of pixels of the solid state image pick-up element is not less than 1,000,000, and the number ranging from 1,000,000 to 2,000,000 is more preferable when capacity of a memory to be used and circuits required in subsequent processing are taken into consideration. The analog signals obtained through the photoelectric conversion are recorded in memory 104 as they are or as digital signals (first image signals) obtained through A/D conversion. It is arranged so that the number of exposures is indicated on frame counter 109 corresponding to operations of the charging mechanism 107. The first image signals stored in memory 104 are outputted to the outside through buffer 105 and connector 106 under the control of CPU 110 representing a means to output to the outside. The CPU 110 makes ID number and the number of exposures to be stored in an internal memory. When photographing for the prescribed number of frames is finished, CPU 110 representing a restriction means can restrict photographing thereafter, independently of remaining capacity for storage of memory 104. Incidentally, it is also possible to arrange so that CPU 110 representing an image signal erasing means may erase a part or the whole of image signals stored in memory 104 when an unillustrated erasure button is pressed.

Electronic still camera 100 in the present embodiment is not provided with an image processing means, which makes the structure to be simple and inexpensive. Electronic still camera 100 in the present embodiment has no LCD for image display, and it is not necessary to apply processing (color conversion and others) for recording and reproducing on the image signals stored in memory 104, which makes the structure to be more simple and inexpensive. The reason is that these processing have only to be conducted on the side of processing apparatus 200 for printing images. Incidentally, though the first image signals stored in memory 104 can be outputted to the outside only when connecting to processing apparatus 200 which will be described later, input of the ID number and password, for example, may also be the condition for the output in this case.

The prescribed condition has only to be one which gives restriction for urging circulation of electronic-image recording apparatuses, and its example includes the number of exposed frames, storage capacity for images resulted from photographing and a period of time from purchasing of an electronic-image recording apparatus.

When the prescribed condition comes, the restriction for photographing has only to be the restriction such as that a shutter release of an electronic-image recording apparatus cannot be pressed, that image pick-up cannot be conducted, that images are not stored in a memory, or that power supply does not rise.

As a variation of the present embodiment, there is also considered an arrangement wherein image processing apparatus 300 including an A/D conversion function is made to be capable of being inserted in connector 106 as shown with dotted lines in FIG. 16, and the first image signal outputted through the connector 106 is subjected to A/D conversion and image processing, and then is outputted to processing apparatus 200. Let it be assumed that the image processing apparatus 300 can be sold in a shape of either unification with or separation from electronic still camera 100.

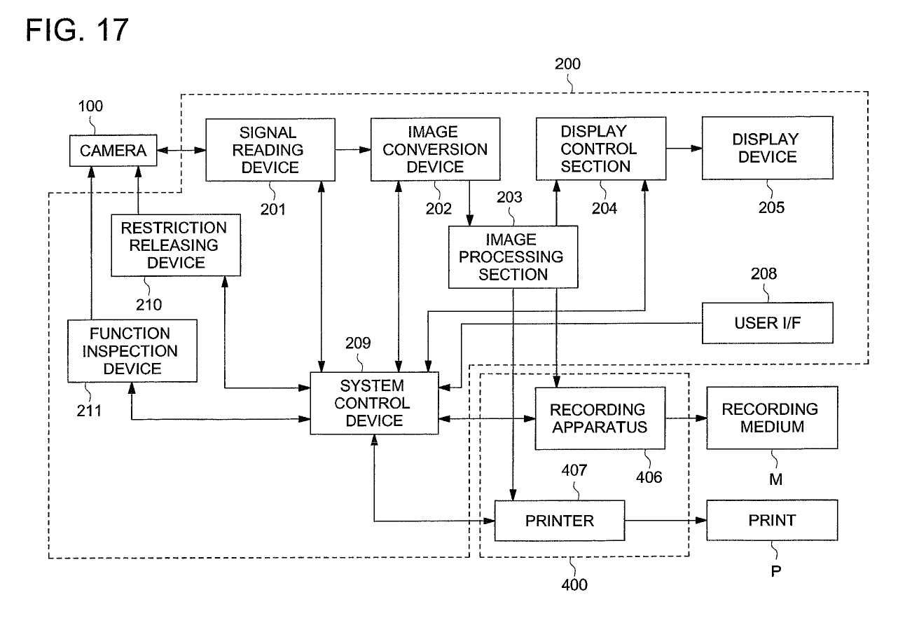

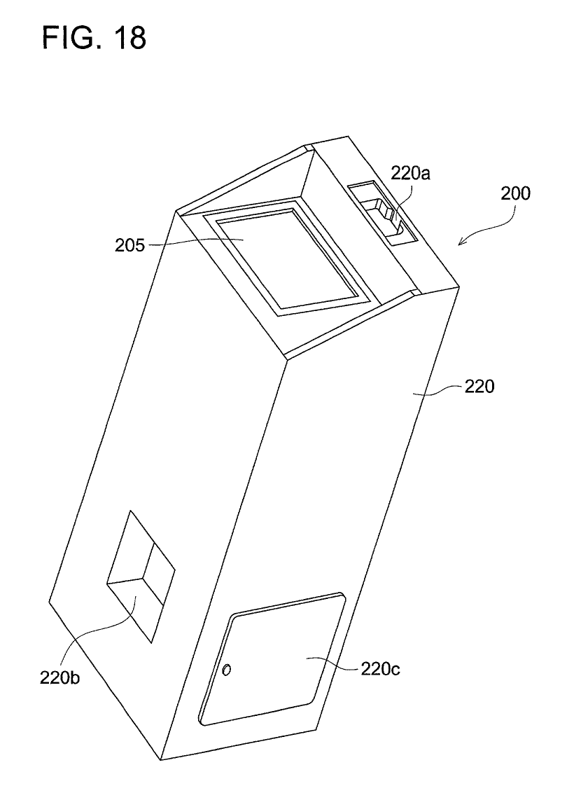

FIG. 17 is a diagram showing processing apparatus 200 constituting a recycling system of an electronic still camera related to the present embodiment, and FIG. 18 is its perspective view. In FIG. 17, the processing apparatus 200 has therein signal reading device 201 that is connected with connector 106 of electronic still camera 100 and reads analog signals, image conversion device 202 that converts the first image signal read out by the signal reading device 201 into digital signal, image processing section 203 representing an image processing means or image processing device that applies prescribed image processing such as color conversion or compression on the digital signal and generates image data (second image signal) in a general-purpose format such as JPEG, display control section 204 that drives display device 205 such as a liquid crystal panel based on the image data generated in the image processing section 203 to display images, user interface 208 such as USB and RS-232C for conducting communication with external equipment, and system control device 209 that is connected to the foregoing to control them.

Incidentally, processing apparatus 200 is provided with recording apparatus 406 representing a recording means that records image data generated in the image processing section 203 owned by digital-compatible equipment 400 installed in a photofinisher described later on recording medium M such as CD-R or DVD-RAM, and printer 407 representing a recording means that forms images on a sheet of paper based on the image data generated in the image processing section 203 and produces print P.

On processing apparatus 200, there may be provided restriction releasing device 210 that releases restriction relating to photographing by electronic still camera 100, and function inspection device 211 that conducts function inspection for electronic still camera 100. As a mode for restriction releasing, it is considered that CPU 110 makes it to be photographable state by input of specific password, but it is also possible, without being limited to the foregoing, to consider that the lock to prevent mechanically and electromagnetically a release switch of electronic still camera 100 from being pressed is released.

In FIG. 18, processing apparatus 200 is covered entirely by casing 220 that is almost in a shape of a rectangular parallelepiped, and on its top, there are formed display device 205 composed of LCD OF a touch panel type, and opening 220a that accepts electronic still camera 100. On the lower portion on the front side of the processing apparatus 200, there is formed ejection outlet 220b through which recording medium M completed in terms of recording and print P (not shown in FIG. 18) are ejected. On the lower portion on the side of the processing apparatus 200, there is formed door 220c of a keeping deposit box where electronic still camera 100 completed in terms of function inspection is kept.

Next, operations of processing apparatus 200 relating to the present embodiment will be explained. FIG. 19 is a flow chart for illustrating the total system including operations of processing apparatus 200 relating to the present embodiment. First, electronic still camera 100 produced by a maker is sold at a retail store as shown in step S101 to be handed to a user. At this point of time, the number of exposures is zero, and it is assumed that a user is informed in advance that photographing up to 24 frames, for example, is possible as an expiration date of the electronic still camera 100.

In step S102, CPU 110 of the electronic still camera 100 forms a judgment whether prescribed number of exposures (24 exposures in the present embodiment) have been covered or not. On this point of time, however, the number of exposures is zero, and CPU 110 judges that the prescribed number of exposures have not been covered accordingly, and allows a user to photograph in step S104, and further judges whether prescribed number of exposures have been covered or not (step S102). Incidentally, it is possible for a user to take or send the electronic still camera 100 to an intermediation store or a photofinisher before the prescribed number of exposures is covered.

On the other hand, when it is judged that the prescribed number of exposures has been covered, CPU 110 controls image pick-up means 103 and prohibits photographing thereafter (step S103). In this case, if release switch 108 becomes impossible to be pressed or if frame counter 109 flashes, for example, a user can learn easily that photographing is not allowed, which is convenient.

Since it is impossible for a user to take out freely image data obtained through photographing with electronic still camera 100 as stated above, the user is urged to take or send the electronic still camera 100 to an intermediation store or a photofinisher after the prescribed number of exposures has been covered. Now, as shown in step S105, when the electronic still camera 100 is taken to the intermediation store, prescribed order acceptance is conducted, and the electronic still camera 100 is sent to a photofinisher.

The electronic still camera 100 taken in a photofinisher is connected to processing apparatus 200, and analog signals stored in memory 104 of the electronic still camera 100 are read through signal reading device 201 (step S106). These analog signals are converted into digital signals in image conversion device 202, and then, prescribed image processing such as color conversion or compression is applied on the digital signals in image processing section 203 and image data in a general purpose format such as JPEG are generated and are sent to digital-compatible equipment 400 in a photofinisher through user I/F (step S107).

In digital-compatible equipment 400 in a photofinisher, image data generated in image processing section 203 depending on a user's request are either recorded on recording medium M through recording apparatus 406, or outputted as print P by printer 407 based on image data. This recording medium M and/or print P can be sent to the user or can be received by the user (step S110) through the intermediation store (step S109) or directly. Since the image data recorded on recording medium M are general purpose image signals in JPEG format, for example, a user can form freely with a personal computer as an image. Further, since the image data are recorded on recording medium M electronically, they are hardly deteriorated with the lapse of time, which makes it possible to obtain images with initial image quality at any time.

System control device 209 of processing apparatus 200 accesses CPU 110 through connector 106 of electronic still camera 100, and it can judge whether the prescribed number of exposures have been covered or not (step S111). In this case, it is also possible to make display device 205 representing a notifying means to display the number of remaining exposures in electronic still camera 100. When system control device 209 judges that photographing for remaining frames is possible because the prescribed number of exposures have not been covered, the electronic still camera 100 can be sent to a user or can be received by a user (step S113) through an intermediation store (step S112) or directly. After the user finishes photographing for remaining frames, the same step can be conducted.

On the other hand, when it is judged, in system control device 209, that no more photographing can be carried out by electronic still camera 100 because prescribed number of exposures have already been finished, there are two modes. Namely, in a photofinisher, it is considered that restriction releasing device 210 of processing apparatus 200 accesses CPU 110 of electronic still camera 100 to release restriction. In this case, electronic still camera 100 on which the restriction has been released is sent to a maker. Contrary to this, it is considered that electronic still camera 100 completed in terms of photographing for the prescribed number of exposures is sent from a photofinisher to a maker where a restriction releasing device in the maker accesses CPU 110 of the electronic still camera 100 to release the restriction (step S114). In such a case, restriction releasing device 210 of processing apparatus 200 installed in a photofinisher is not used.

On the maker side, CPU 110 of the electronic still camera 100 received is accessed, and a camera ID number is changed to the new one (step S115). After that, functions of the electronic still camera 100 is inspected in step S116, and parts whose functions are deteriorated, if any, are repaired or replaced (step S117), then, the electronic still camera 100 is sold at a retail store again (step S101). Even in this case, function inspection device 211 of processing apparatus 200 installed in a photofinisher is not used, thereby, it may also be returned to a maker after it is used for function inspection for electronic still camera on the photofinisher side.

In the present embodiment, CPU 110 of the electronic still camera 100 representing a restriction means restricts photographing when the number of exposures made reaches a prescribed number, making it impossible to photograph, which makes a user to learn that an expiration date of the electronic still camera 100 has expired. On the other hand, the user is urged to take the electronic still camera 100 wherein no photographing is allowed to a photofinisher because it is impossible for the user to take out image data, which makes it possible to improve the collection rate of electronic still camera 100. Further, at a photofinisher or a maker to which electronic still cameras are collected, restriction releasing device 210 releases the restriction by CPU 110 to attempt reuse of necessary parts, and function inspection device 211 representing a processing means conducts a prescribed inspection for the reuse of the collected electronic still cameras, thus, it is easy to judge the parts which can be used again.

In addition to the function inspection processing for electronic still camera 100 and the processing to change ID information stored in CPU 110, the prescribed processing for the reuse includes processing for initializing CPU 110 of electronic still camera 100 and processing to erase contents stored in memory 104. Further, processing to replace the parts which are not usable, for example, is included, and charging processing is included when an electronic-image recording apparatus has a charging type battery. Further, it is also possible to install processing apparatus 200 at a maker.

Incidentally, the invention is not limited to the embodiment stated above, and it can naturally be changed or improved. For example, a prescribed condition for restricting photographing can also be a prescribed period of time from the start of photographing, in place of the prescribed number of exposures. It is further possible to make an arrangement wherein a releasing means for releasing a restriction means of an electronic-image recording apparatus is provided in the present embodiment, and an electronic-image recording apparatus is kept in a keeping means after the restriction for photographing is released by the releasing means.

(Sixth Embodiment)

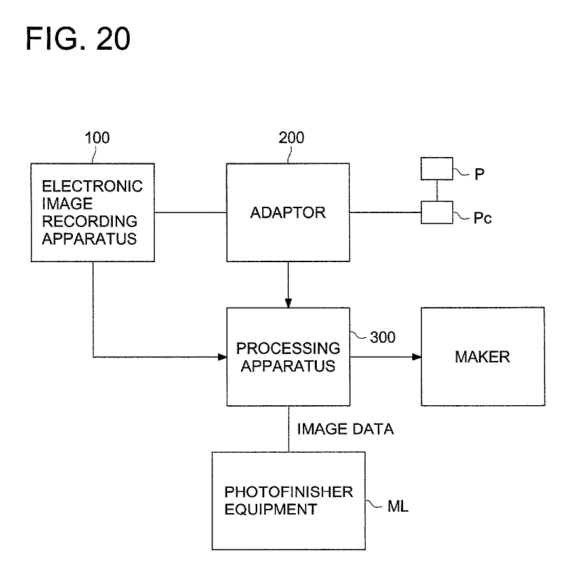

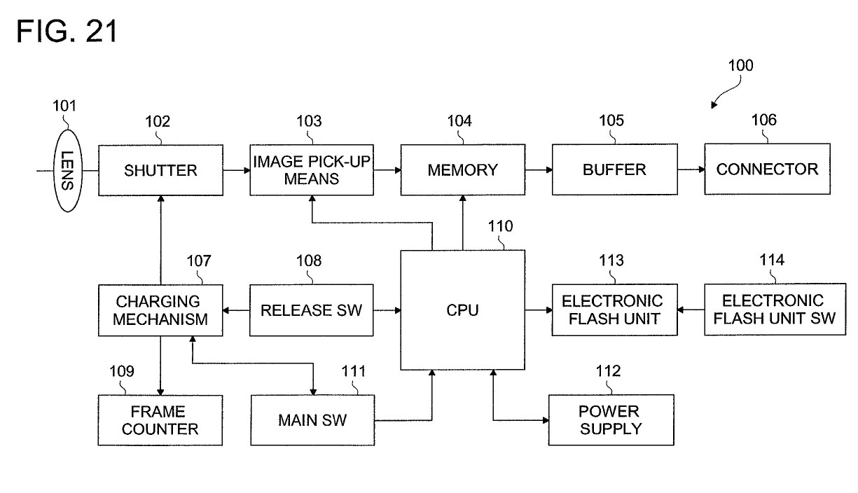

The embodiment of the invention will be explained as follows, referring to FIGS. 20-24. FIG. 20 is a schematic diagram of the total system in the present embodiment., and FIG. 21 is a block diagram of electronic still camera 100 related to the present embodiment. In the present embodiment, electronic still camera 100 and adaptor 200 or processing apparatus 300 constitute an electronic-image recording apparatus or an image recording system. Further, electronic still camera 100, adaptor 200 and printer P, or electronic still camera 100 and processing apparatus 300 (and photofinisher equipment ML) constitute an image recording and reproducing system. With regard to items which are the same as those in the first embodiment-fifth embodiment, explanation thereof will be omitted.

A user uses an electronic-image recording apparatus such as, for example, electronic still camera 100 to photograph. Since it is impossible for electronic still camera 100 alone to output in a shape to utilize image signals, an output is conducted to, for example, outer personal computer Pc through adaptor 200, and images can be printed through printer P connected to the outer personal computer. Incidentally, photographing by electronic still camera 100 is restricted, or prohibited, for example, when the prescribed condition is satisfied, namely, for example, when photographing for the prescribed number of frames has been finished. Adaptor 200 has a function to release the restriction mentioned above. A user can acquire the adaptor 200 through a rental basis or a purchasing basis.

On the other hand, after the user who does not desire the use of adaptor 200 takes the exposed electronic still camera 100 to a photofinisher, image signals stored in the electronic still camera 100 can be read out and converted into image data by processing apparatus 300. Further, by using the image data obtained through conversion, it is possible to make prints on photofinisher equipment ML having printing functions. Then, the restriction which has been applied on the electronic still camera 100 is released by processing apparatus 300. Due to this, the electronic still camera 100 can be used again. From this state, the electronic still camera 100 can be collected to a maker. In the processing apparatus 300, it is also possible to arrange so that parts and functions of the electronic still camera 100 may be inspected. The electronic still camera 100, adaptor 200 and the processing apparatus 300 will be explained concretely as follows.

In the electronic still camera 100 shown in FIG. 21, when main switch 111 is turned on, electric power is supplied to CPU 110 from power supply 112 such as a battery, and image pick-up means 103 such as CCD, memory 104 representing a recording means and electronic flash unit 113 are controlled by the CPU 110. The electronic flash unit 113 containing a capacitor for luminescence is arranged so that electric charging for luminescence may be started only when electronic flash switch 114 is turned on.

Further, when release switch 108 is turned on and charging mechanism 107 drives shutter 102 accordingly, image pick-up means 103 representing a photoelectric conversion means whose light-receiving surface is subjected to forming of an optical image by taking lens 101 through opened shutter 102 conducts the so-called photoelectric conversion for outputting analog signals (first image signal) corresponding to an optical image of a subject, under the control of CPU 110. As an image pick-up means, it is possible to use a solid state image pick-up element such as CCD conducting photoelectric conversion and CMOS. For obtaining images having high image quality, it is preferable that the number of pixels of the solid state image pick-up element is not less than 1,000,000, and the number ranging from 1000000 to 2000000 is more preferable when capacity of a memory to be used and circuits required in subsequent processing are taken into consideration. The analog signals obtained through the photoelectric conversion are recorded in memory 104 as they are or as digital signals (first image signals) obtained through A/D conversion. It is arranged so that the number of exposures is indicated on frame counter 109 corresponding to operations of the charging mechanism 107. The first image signals stored in memory 104 are outputted to the outside through buffer 105 and connector 106 under the control of CPU 110 representing an image signal outputting means. The CPU 110 makes ID number and the number of exposures to be stored in an internal memory. When photographing for the prescribed number of frames is finished, CPU 110 representing a restriction means can restrict photographing thereafter, independently of remaining capacity for storage of memory 104. Incidentally, it is also possible to arrange so that CPU 110 representing an image signal erasing means may erase either a part or the whole of images signals stored in memory 104 when an unillustrated erasure button is pressed.

Electronic still camera 100 in the present embodiment is not provided with an image processing means, which makes the structure to be simple and inexpensive. Further, electronic still camera 100 of the present embodiment can be of the simple and inexpensive structure, because it has no LCD for image display, and it does not need to apply processing (color conversion and others) for recording and reproduction on image signals stored in memory 104. The reason for the foregoing is that these processing can be conducted on the part of adaptor 200 for printing images or processing apparatus 300. Incidentally, though the first image signals stored in memory 104 can be outputted to the outside only when connecting to adaptor 200 described later or processing apparatus 300, input of the ID number or a password, for example, may also be the condition for the output, in this case.

The prescribed condition has only to be one which gives restriction for urging circulation of electronic-image recording apparatuses, and its example includes the number of exposed frames, storage capacity for images resulted from photographing and a period of time from purchasing of an electronic-image recording apparatus.

When the prescribed condition comes, the restriction for photographing has only to be the restriction such as that a shutter release of an electronic-image recording apparatus cannot be pressed, that image pick-up cannot be conducted, that images are not stored in a memory, or that power supply does not rise.

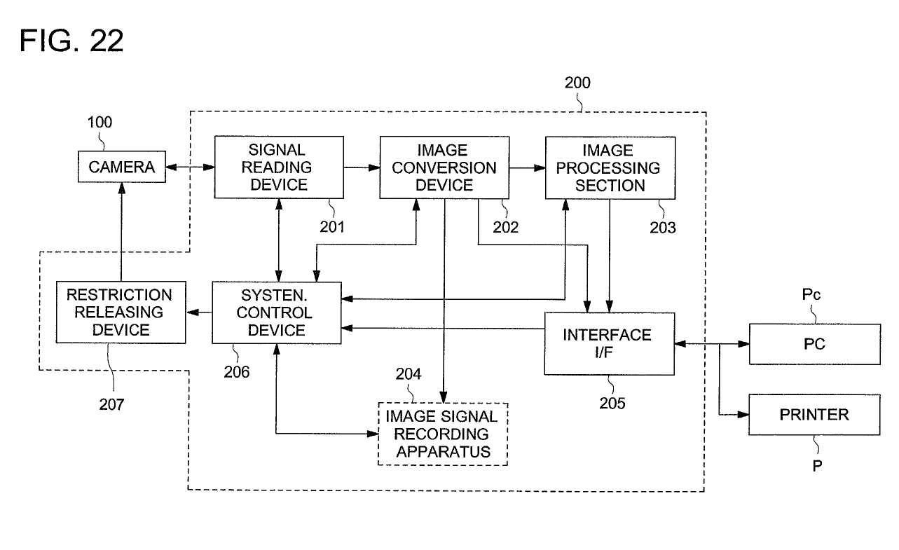

FIG. 22 is a diagram showing adaptor 200 of an electronic still camera related to the present embodiment. The adaptor 200 constituting a processing apparatus has functions to connect electronic still camera 100 with personal computer Pc and to convert image signals obtained through photographing by the electronic still camera 100 into a general-purpose format type to output to the personal computer Pc side.

In FIG. 22, adaptor 200 has therein signal reading device 201 representing a reading means that is equipped with a plug (not shown) in a shape connectable with connector 106 of electronic still camera 100, image conversion means 202 that converts the first image signals representing non-digital signals read out by the signal reading device 201 into digital signals, image processing section 203 that applies prescribed image processing such as color conversion and compression on the digital signals and generates image data (second image signals) in a general-purpose format type such as JPEG, image signal storage device 204 that stores digital signals resulted from conversion, interface 205 such as USB and RS-232C for conducting communication with external personal computer Pc, restriction releasing device 207 that releases restriction on electronic still camera 100, and system control device 206 that is connected to the foregoing to control them.

Next, operations of the adaptor 200 will be explained. First, at a point of time when electronic still camera 100 is supplied from a maker, the number of frames exposed in the electronic still camera 100 is zero, and a user who purchased the electronic still camera 100 at a low price or who was given the electronic still camera 100 free of charge is informed in advance that photographing up to 24 frames, for example, is possible as an expiration date of the electronic still camera 100.

Since CPU 110 of the electronic still camera 100 forms a judgment whether prescribed number of exposures (24 exposures in the present embodiment) have been covered or not, it is possible for a user to photograph up to the prescribed number of frames.

When photographing for the prescribed number of frames has been finished, CPU 110 of electronic still camera 100 representing a restriction means controls image pick-up means 103 and prohibits photographing thereafter. In this case, if release switch 108 becomes impossible to be pressed or if frame counter 109 flashes, for example, a user can learn easily that no further photographing is allowed, which is convenient.

Incidentally, since a shape of connector 106 is specific, an ordinary cable cannot connect the connector 106 to the electronic still camera 100. Further, since electric signals coming from image pick-up means 103 are stored in memory 104 of the electronic still camera 100 as they are, electric signals cannot be used as they are, even when the electric signals are read out of the memory 104. Therefore, a user having only electronic still camera 100 cannot obtain a print of images as they are.

Accordingly, a user who desires a print of images needs to have adaptor 200. Adaptor 200 that is mountable on and dismountable from electronic still camera 100 can be purchased together with electronic still camera 100 by a user. However, in the present embodiment, let it be assumed that adaptor 200 is available on a rental basis separately from electronic still camera 100. A user having personal computer Pc can connect the personal computer Pc with electronic still camera 100 through adaptor 200. On the other hand, a user having no personal computer Pc can connect electronic still camera 100 with personal computer Pc installed in a photofinisher through adaptor 200.

Signal reading device 201 of adaptor 200 inputs certification information such as a password in electronic still camera 100 from restriction releasing device 207 first, then, releases output restriction by CPU 110 representing an output restriction means, and accesses memory 104 of the electronic still camera 100, thereby, the signal reading device 201 can read electric signals stored. Image conversion device 202 is arranged to convert analog signals read out by signal reading device 201 into digital signals. It is arranged so that prescribed image processing such as color conversion and compression are applied in image processing section 203 based on the digital signals stated above, and thereby, image data (second image signals) are generated in a general-purpose format type such as JPEG. Since these image data can be read by any personal computer, it is so arranged that the image data are outputted to outer personal computer Pc through interface 205 to be displayed as an image by a display or to be printed by printer P attached. Image signal recording apparatus 204 is used when digital signals resulted from conversion are stored temporarily.

Incidentally, when outer personal computer Pc is provided with software which applies prescribed image processing such as color conversion and compression based on digital signals, and generates image data (second image signals) in a general-purpose format type such as JPEG, image processing section is not used.

Incidentally, when using adaptor 200 on a rental basis, it is rational if a charge can be calculated based on frequency of the use of adaptor 200. On the contrary, in the present embodiment, system control device 206 of adaptor 200 houses therein a timer so that the aggregated time during which image signals have been outputted to the outside through interface 205 may be counted. When a user returns adaptor 200, the reading time is known if the counted time is checked. Therefore, a person who controls an adaptor can collect (accounting) additional charge corresponding to the counted time, when a user returns adaptor 200. Incidentally, it is also considered that system control device 206 calculates an additional charge from the counted time and makes an unillustrated LCD to display it, or makes a display of personal computer Pc to display through interface 205.

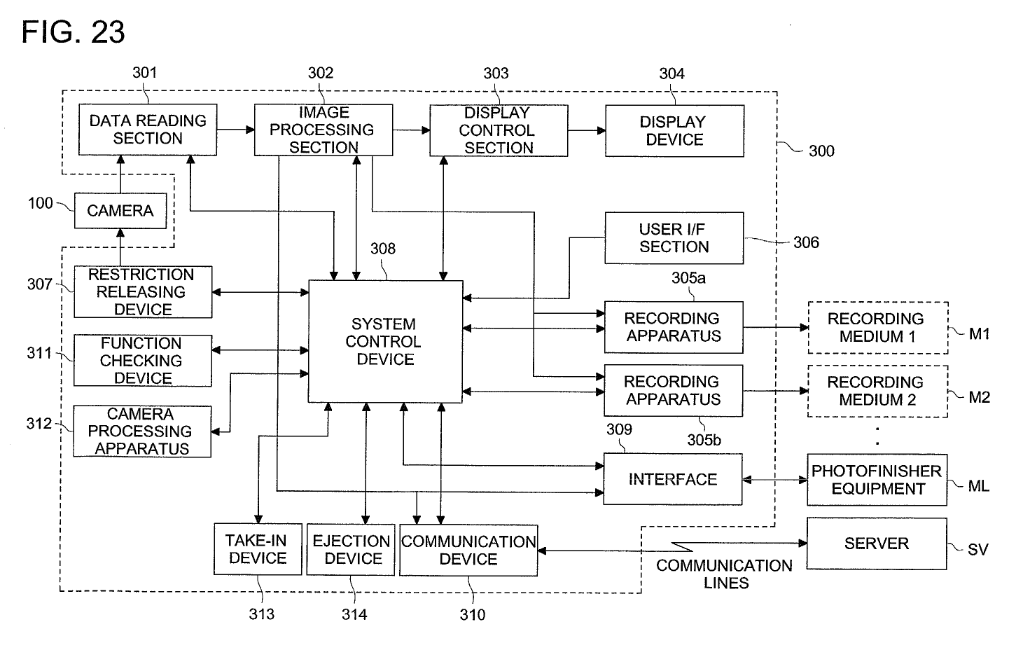

FIG. 23 is a diagram showing processing apparatus 300 for an electronic still camera related to another embodiment, and FIG. 24 is its perspective view. The processing apparatus 300 is installed, for example, in a photofinisher, and it has a function to convert image signals obtained through photographing by electronic still camera 100 into a general-purpose format type and to write them on a recording medium, and a function to check function defects of the electronic still camera 100 and to fix, when the function is inappropriate.

In FIG. 23, the processing apparatus 300 has therein data reading section 301 representing a reading means that is equipped with a plug in a shape connectable with connector 106 of electronic still camera 100 and can read analog signals, image processing section 302 that converts analog signals read out by the data reading section 301 into digital signals, then, applies prescribed image processing such as color conversion and compression, and generates image data (second image signals) in a general-purpose format type such as JPEG, display control section 303 that makes display device 304 to display images based on the general-purpose image data, image recording apparatuses 305a and 305b which write the general-purpose image data respectively on recording medium M1 (for example, CD-ROM) and recording medium M2 (for example, DVD-ROM), interface 306 such as USB and RS-232C for communicating with outer personal computer Pc, restriction releasing device 307 that releases restriction of electronic still camera 100, and system control device 308 that is connected to the foregoing and conducts controlling. The image recording apparatuses 305a and 305b may also be separate from the processing apparatus 300.

Further, the processing apparatus 300 is provided with interface 309 that makes it possible to transmit image data to photofinisher equipment ML representing an image recording apparatus which is controlled by system control device 308 and can print highly detailed images, communication device 310 that makes it possible to transfer, through communication lines, image data to outer server SV capable of storing a large quantity of image data, function checking device 311 that checks functions of electronic still camera 100, camera processing apparatus 312 that replaces or repairs parts which make functions of electronic still camera 100 to be inappropriate, take-in device 313 for electronic still camera 100, and with ejection device 314.

In FIG. 24, processing apparatus 300 is covered entirely by casing 320, and on its top, there are formed display device 304 composed of LCD OF a touch panel type, and opening 320a that accepts electronic still camera 100. On the lower portion on the front side of the processing apparatus 300, there is formed ejection outlet 320b through which recording media M1 and M2 completed in terms of recording are ejected. On the lower portion on the side of the processing apparatus 300, there is formed door 320c of a keeping deposit box where electronic still camera 100 completed in terms of function inspection is kept.

Next, operations of the processing apparatus 300 will be explained. First, at a point of time when electronic still camera 100 is supplied from a maker, the number of frames exposed in the electronic still camera 100 is zero, and a user who purchased the electronic still camera 100 at a low price or who was given the electronic still camera 100 free of charge is informed in advance that photographing up to 24 frames, for example, is possible as an expiration date of the electronic still camera 100.

Since CPU 110 of the electronic still camera 100 forms a judgment whether prescribed number of exposures (24 exposures in the present embodiment) have been covered or not, it is possible for a user to photograph up to the prescribed number of frames.

When photographing for the prescribed number of frames has been finished, CPU 110 of electronic still camera 100 representing a restriction means controls image pick-up means 103 and prohibits photographing thereafter. In this case, if release switch 108 becomes impossible to be pressed or if frame counter 109 flashes, for example, a user can learn easily that no further photographing is allowed, which is convenient.

Incidentally, since a shape of connector 106 is specific, an ordinary cable cannot connect the connector 106 to the electronic still camera 100. Further, since electric signals coming from image pick-up means 103 are stored in memory 104 of the electronic still camera 100 as they are, electric signals cannot be used as they are, even when the electric signals are read out of the memory 104. Therefore, a user having only electronic still camera 100 cannot obtain a print of images as they are.

In that case, a user who desires general-purpose image data under the condition of recovery of electronic still camera 100 can take the electronic still camera 100 to a photofinisher where the processing apparatus 300 is installed. When the user or an operator of the photofinisher inserts the electronic still camera 100 in opening 320a shown in FIG. 24, data reading section 301 of the processing apparatus 300 is connected with connector 106 of the electronic still camera 100 to be ready for data reading.

Data reading section 301 of the processing apparatus 300 inputs certification information such as a password in electronic still camera 100 from restriction releasing device 307 first, then, releases output restriction by CPU 110, and accesses memory 104 of the electronic still camera 100 to read electric signals stored. Image processing section 302 converts analog signals read out into digital signals, then, applies prescribed image processing such as color conversion and compression based on the digital signals, and generates image data (second image signals) in a general-purpose format type such as JPEG. These image data are recorded on recording media M1 and M2 by recording apparatuses 305a and 305b, and the recorded data are general-purpose image data which can be read by any personal computer and can be freely used for printing and image composition. Recording media M1 and M2 are ejected by ejection device 314 to ejection outlet 320b (FIG. 7).

Further, these image data are transmitted to photofinisher equipment ML through interface 205 to be printed as highly detailed images in the photofinisher equipment ML, and are transferred to server SV through communication device 310 to be preserved as backup data. Further, function checking device 311 checks functions of electronic still camera 100, and when functions of the electronic still camera 100 are inappropriate, camera processing apparatus 312 replaces and repairs defective parts. The repaired electronic still camera 100 is kept in a keeping deposit box of processing apparatus 300.

Further, in the present embodiment, system control device 308 of processing apparatus 300 uses a timer housed therein to count the aggregated time during which image signals are outputted to photofinisher equipment ML through, for example, interface 309, and/or obtains an amount of data recorded by recording apparatuses 305a and 305b on recording media M1 and M2. Based on the counted time and/or an amount of data, it is possible for a photofinisher to collect service charge corresponding to the counted time and/or an amount of data. In that case, it is considered that the system control device 308 makes the display device 304 to display the calculated service charge, or makes an unillustrated printer to print the calculated service charge.

In the embodiment stated above, CPU 110 of the electronic still camera 100 representing a restriction means restricts photographing when the number of exposures made reaches a prescribed number, making it impossible to photograph, which makes a user to learn that an expiration date of the electronic still camera 100 has expired. On the other hand, on the user side, the electronic still camera 100 wherein no photographing is allowed is connected to adaptor 200 or to processing apparatus 300 to convert into desired image data, because it is not possible to take out image data freely. In this case, rational accounting is possible at need. Further, it is urged that electronic still camera 100 is taken to a photofinisher, and thereby, the rate of collection of electronic still camera 100 can be improved. Incidentally, in processing apparatus 300, prescribed processing for reuse such as function checking is conducted before the electronic still camera 100 is collected to a maker, which is a merit that time and labor on the maker side can be saved.

Now, the prescribed processing for reuse includes processing to initialize CPU 110 of electronic still camera 100 and processing to erase contents stored in memory 104, in addition to processing of function inspection for electronic still camera and processing to change ID information recorded in CPU 110. Further, processing to replace parts which are not usable, for example, and processing for charging when an electronic-image recording apparatus has a charging type battery are also included. It is further possible to install processing apparatus 300 in a maker.

The invention is not limited to the embodiment stated above, and it is naturally possible to modify and improve. It is also possible to make an arrangement wherein a releasing means for releasing a restriction means of an electronic-image recording apparatus is provided, and an electronic-image recording apparatus is kept in a keeping means after the restriction for photographing is released by the releasing means.

The invention makes it possible to provide an electronic-image recording apparatus such as an inexpensive electronic still camera.

The invention makes it possible to provide a recovery apparatus for an image forming apparatus which can conduct recovery efficiently and a recovery system employing the recovery apparatus.

The invention makes it possible to provide a processing apparatus for an electronic image forming apparatus which can conduct recovery efficiently and can conduct reoffering and a recycling system employing the processing apparatus.

Disclosed embodiment can be varied by a skilled person without departing from the spirit and scope of the invention.

What is claimed is:

1. A system for recycling an electronic-image recording apparatus, which includes a restricting device to restrict an image-capturing operation under a predetermined condition occurring after use of said electronic-image recording apparatus, comprising:
a readout section to read a first image signal in the basis of an image signal stored in said electronic-image recording apparatus;
a converting section to convert said first image signal, read by said readout section, into a second image signal; and
a canceling section to cancel the image-capturing restriction set by said restricting device included in said electronic-image recording apparatus.

2. The system of claim 1, further comprising:
a processing section for applying a predetermined processing to said electronic-image recording apparatus, in order to reuse it.

3. The system of claim 2,
wherein said processing section conducts a mechanical inspection process for said electronic-image recording apparatus.

4. The system of claim 2,
wherein said electronic-image recording apparatus memorizes identification data, and said processing section changes said identification data memorized in said electronic-image recording apparatus.

5. The system of claim 2,
wherein said processing section initializes said electronic-image recording apparatus.

6. The system of claim 2,
wherein said processing section erases data memorized in said electronic-image recording apparatus.

7. The system of claim 2,
wherein said processing section exchanges unusable and/or worn-out parts of said electronic-image recording apparatus with new parts.

8. The system of claim 1, further comprising:
a recording section to record image information on a recording medium, based on said second image signal.

9. The system of claim 8,
wherein said recording section records said image information on said recording medium in a visible form.

10. The system of claim 8,
wherein said recording section stores said image information in said recording medium in a form of digital data.

11. The system of claim 1, further comprising:
an image-capturable state notifying section to notify that a number of images, recorded in said electronic-image recording apparatus, is with in a range of a predetermined number, when the number of images does not exceed said predetermined number of images to be stored in said electronic-image recording apparatus.

12. The system of claim 1, further comprising:
an inserting section into which said electronic-image recording apparatus can be inserted; and
a storing section to store said electronic-image recording apparatus from which said first image signal is already read out by said readout section, in such a manner that a person, other than predetermined personnel, cannot remove said electronic-image recording apparatus from said storing section.

13. The system of claim 1,
wherein said second image signal is a general purpose image signal.

14. The system of claim 1,
wherein said first image signal is an image signal memorized in said electronic-image recording apparatus as digital signals.

15. The system of claim 1,
wherein said first image signal is digital image signals converted from an image signal, memorized in said electronic-image recording apparatus as analogue signals, through an analogue-to-digital conversion process.
